(19) United States
(12) Patent Application Publication
(10) Pub. No.: US 2016/0171555 A1
(43) Pub. Date: Jun. 16, 2016

(54) Method and System for Customer Evaluation and Development/Provision of Multiple Types of Varied and Pre-Approved Customized Product Offers to Evaluated Customers for On-Demand Acceptance and Fulfillment

(71) Applicant: CUneXus Solutions, Santa Rosa, CA (US)

(72) Inventors: David A. Buerger, Santa Rosa, CA (US); Darin L. Chong, Santa Rosa, CA (US); John Reich, Healdsburg, CA (US)

(73) Assignee: CUneXus Solutions, Santa Rosa, CA (US)

(21) Appl. No.: 14/968,824

(22) Filed: Dec. 14, 2015

Related U.S. Application Data
(63) Continuation of application No. 12/389,858, filed on Feb. 20, 2009, now abandoned.
(60) Provisional application No. 61/030,710, filed on Feb. 22, 2008.

(51) Int. Cl. G06Q 30/02; G06Q 40/02

(52) U.S. Cl. CPC G06Q 30/0269; G06Q 40/025

(57) ABSTRACT

This invention relates to a system that generates pre-approved financial product offers, such as credit offers, after evaluating information retrieved from internal and/or external databases which contain customer information. The system is particularly suitable for generating pre-approved multi-product offers from the suite of products a user institution has available in addition to a default offer.

### CROSS REFERENCE TO RELATED APPLICATIONS

This application is a continuation application claiming priority to application Ser. No. 12/389,858, filed on Feb. 20, 2009, which claims the benefit of U.S. Provisional Patent Application 61/030,710, filed 22 Feb. 2008.

### STATEMENT REGARDING FEDERALLY SPONSORED RESEARCH OR DEVELOPMENT

Not applicable.

### TECHNICAL FIELD OF INVENTION

This invention relates to the field of evaluation of customers and development and provision of multiple types of varied and pre-approved customer product offers for on-demand acceptance and fulfillment.

### BACKGROUND OF THE INVENTION

In the 1960s, the Defense Department wanted to develop a communication system that would permit communication between these different computer networks. Recognizing that a single, centralized communication system would be vulnerable to attacks or sabotage, the Defense Department required that the communication system be decentralized with no critical services concentrated in vulnerable failure points. In order to achieve this goal, the Defense Department established a decentralized communication protocol for communication between their computer networks.

A few years later, the National Science Foundation (NSF) wanted to facilitate communication between incompatible network computers at various research institutions across the country. The NSF adopted the Defense Department's protocol for communication, and this combination of research computer networks would eventually evolve into the Internet.

The Defense Department's communication protocol governing data transmission between different networks was called the Internet Protocol (IP) standard. The IP standard has been widely adopted for the transmission of discrete information packets across network boundaries. In fact, the IP standard is the standard protocol governing communications between computers and networks on the Internet.

The IP standard identifies the types of services to be provided to users and specifies the mechanisms needed to support these services. The IP standard also specifies the upper and lower system interfaces, defines the services to be provided on these interfaces, and outlines the execution environment for services needed in the system.

A transmission protocol, called the Transmission Control Protocol (TCP), was developed to provide connection-oriented, end-to-end data transmission between packet-switched computer networks. The combination of TCP with IP (TCP/IP) forms a suite of protocols for information packet transmissions between computers on the Internet. The TCP/IP standard has also become a standard protocol for use in all packet switching networks that provide connectivity across network boundaries.

In a typical Internet-based communication scenario, data is transmitted from an originating communication device on a first network across a transmission medium to a destination communication device on a second network. After receipt at the second network, the packet is routed through the network to a destination communication device. Because standard protocols are used in Internet communications, the IP protocol on the destination communication device decodes the transmitted information into the original information transmitted by the originating device.

A computer operating on a network is assigned a unique physical address under the TCP/IP protocols. This is called an IP address. The IP address can include: (1) a network ID and number identifying a network, (2) a sub-network ID number identifying a substructure on the network, and (3) a host ID number identifying a particular computer on the sub-network. A header data field in the information packet will include source and destination addresses. The IP addressing scheme imposes a consistent addressing scheme that reflects the internal organization of the network or sub-network.

A router, agent or gateway is used to regulate the transmission of information packets into and out of the computer network. Routers interpret the logical address contained in information packet headers and direct the information packets to the intended destination. Information packets addressed between computers on the same network do not pass through the router to the greater network, and as such, these information packets will not clutter the transmission lines of the greater network. If data is addressed to a computer outside the network, the router forwards the data onto the greater network.

The Internet protocols were originally developed with an assumption that Internet users would be connected to a single, fixed network. With the advent of cellular wireless communication systems, such as mobile communication devices, the movement of Internet users within a network and across network boundaries has become common. Because of this highly mobile Internet usage, the implicit design assumption of the Internet protocols (e.g. a fixed user location) is violated by the mobility of the user.

In an IP-based mobile communication system, the mobile communication device (e.g. cellular phone, pager, computer, etc.) can be called a Mobile Node. Typically, a Mobile Node maintains connectivity to its home network through a foreign network. The Mobile Node will always be associated with its home network for IP addressing purposes and will have information routed to it by routers located on the home and foreign networks. The routers can be referred to by a number of names including Home Agent, Home Mobility Manager, Home Location Register, Foreign Agent, Serving Mobility Manager, Visited Location Register, and Visiting Serving Entity.

In order to procure a loan from a bank, consumers currently need to submit and have processed separate credit applications that must be separately evaluated for each financial product loan offering from a financial institution. Banks and financial institutions most often offer a suite of loan products, some or all of which are made available to a consumer of the bank services. Even when consumers are approved for one bank offering, a bank or financial institution still requires that separate applications (e.g. credit checks, application submissions, etc.) be submitted and evaluated before fulfilling different product offerings in a multiple-product suite of products.

This requirement for separate back-end application processing, and further approval, credit or other bank approvals, is needed even if a lender wishes to offer pre-approved products to an individual consumer. There exists a significant problem in the market in light of the need for a lender or financial institution to submit and analyze separate credit reports, underwriting applications, and communication/delivery processing paperwork for each product in a suite of products or product categories. These traditional methods fail to integrate all available delivery channels and customer touch points, and are often communicated to potential customers solely via direct mail. Many consumers find these direct mail initiatives to be bothersome and invasive, regarding such communication as “junk-mail” or “junk e-mail.”

Several patents show these traditional methods of submitting offers that require back-end approvals and documentation review or separate loan application submissions prior to fulfillment of a loan offering. For example, U.S. Patent Publ. No. 2006/0080251 to Fried shows the mere solicitation or invitation for a consumer to apply for a loan product including the need for a financial institution to conduct additional financial analysis and post-offer approvals following the customer submission of an application in response to the solicitation. Like Fried, U.S. Patent Publ. No. 2004/0103065 to Kishen shows a mere solicitation or invitation to apply for a product to customers to apply for a financial product where the financial institution conducts additional financial analysis and approvals after the customer submits an application in response to the solicitation. Also, U.S. Patent Publ. No. 2007/0288359 to Amadio shows a financial “line of credit” that is composed of a single product offering, not multiple products in a suite of products. Any offering of another loan product outside the single line of credit to a consumer using the Amadio system would still require a separate “back-end” financial review and separate approval process.

The solicitation or offer from the finanical institution in Fried and Kishen, and for that matter, Amadio are not “pre-approved” offers of products in a multiple product offering because neither of these systems provide offers to customers for an immediate on-demand acceptance, especially where the product offerings are varied types of multiple-product suites of products. These types of traditional methods and systems used in the market fail to utilize the advancements in technology and process automation, and the current methods and systems are not optimized for operational efficiency, consumer expectation, and business strategy within the financial services industry. None of the current systems on the market are used by financial institutions and other lender companies to evaluate and qualify customers for pre-approved offers that can be distributed and provided to customers for an immediate on-demand acceptance, especially where the product offerings are varied types of multiple-product suites of products with all the functionality included in the present invention.

### BRIEF DESCRIPTION OF THE DRAWINGS

FIG. 1A is block diagrams showing system components used with the present invention,

FIG. 1 is a flowchart of the software modules interactions employed by a system of the invention,

FIG. 2 is a flowchart showing how profile codes are created,

FIG. 3 is the Enterprise Architecture used by the present invention,

FIG. 4 is a diagram illustrative of message flows and communication links used in the present invention;

FIGS. 5-6 show the screen displays for different types of mobile units as generated according to the present invention,

FIG. 7A-7E show the screen displays for a mobile unit as generated according to the present invention,

FIG. 8A-8H show the screen displays for a mobile unit as generated according to the present invention,

FIG. 9A-9M show the screen displays for a mobile unit as generated according to the present invention, and

FIG. 10A-10J show the screen displays for a mobile unit as generated according to the present invention.

### SUMMARY OF THE INVENTION

The present invention was technology developed to assist lenders in evaluation of customers and the making of loan decisions, as well as providing customers with a mobile platform supporting the extension of pre-approved offers of a suite of different types of loan products to bank customers and consumers. Pre-approved loan offers are “firm offers of credit that have been approved by the financial institution and can be funded and fulfilled by a financial institution on a real-time, immediate basis without the need for further application processing and approvals by the financial institution.” Funding and fulfillment of the pre-approved loan can be accomplished “on-demand,” which also means that they “can be funded and fulfilled by a financial institution on an immediate basis without the need for further application processing, evaluation and approvals by the financial institution.”

A client or customer that receives a pre-approved offer can access the benefits of a loan product over the system, which may be accessed on mobile or network based computers, on an on-demand basis, which means they can receive funding, with a simple approval from the client and fulfillment of the loan offer by the financial institution. By “on-demand” acceptance, the invention supports the immediate fulfillment and funding of the pre-approved loan offer after the demand is sent by the customer through their acceptance and approval of the loan offer.

The present communication system having the following functionalities: (1) customer evaluation and pre-approval for multiple varied product suite; (2) database retention of pre-approved customers; (3) determination of which loan products get approved and how much is approved for each product; (4) communication of pre-approved product suite of different types of loan products to customers; (5) fulfillment and funding of on-demand acceptance of pre-approved offer; (6) updating system after fulfillment of accepted pre-approved offer by customer; (7) geo-targeting of customers of pre-approved offers; (8) push notices to customers at opportune timing to deliver up to date pre-approved offer to customer at the opportune moment; (9) valuation bar and database access products that are being shopped by customer; (10) approved and guaranteed pricing for shopped items; (11) real-time local product or service inventory database access; (12) calculator regarding monthly payments at predetermined interest rates with an input down payment amount; (13) product code scanner recognition (e.g. VIN code, bar code); and, (14) loan document generation/signature capture.

### DETAILED DESCRIPTION

The present invention is a communication system supporting the processing communications between a home agent network and a mobile unit, where the home agent network associated has a home agent coupled to a computer server. The home network processes communications to be transmitted and received from a mobile unit, and a transceiver unit is coupled to said home agent network for receiving and transmitting communications to said mobile unit. The home agent network processes communications to and from said mobile unit, and information related to the mobile nodes location and proximity are used to include selected communications that possess information and data relating to specific products or ordering information.

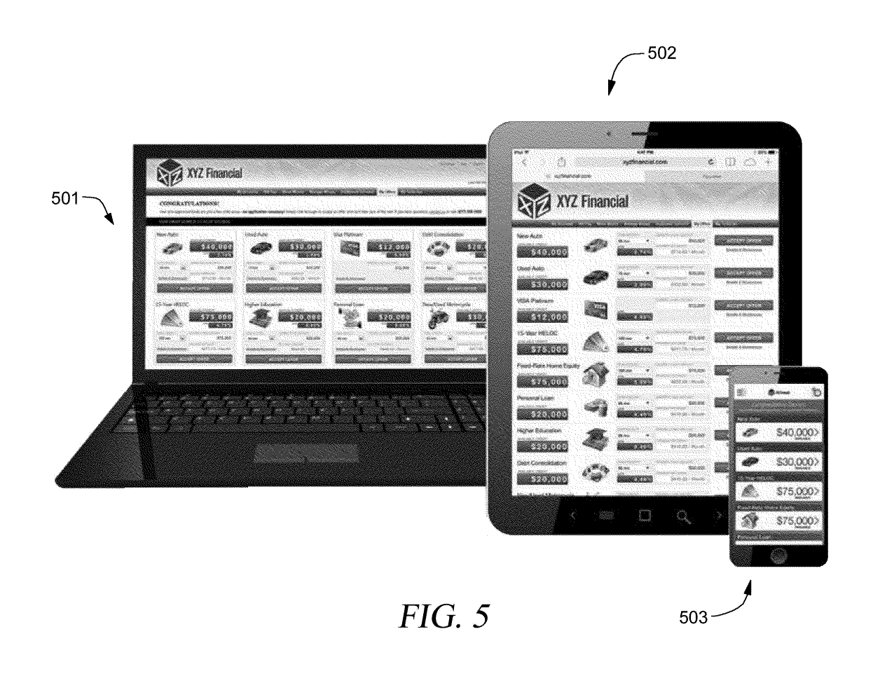

The communication system identified above communicates predetermined information and data such as available products in local inventories, pricing information on the same type of products. Specific embodiments will be discussed with respect to FIGS. 5, 6, 7A-7E, 8A-8H, 9A-9M and 10A-10J, but each of these embodiments support a WiFi connection (or similar mobile network connection) that allows the pushing of data onto the hand-held mobile device. By “pushing,” the invention will use the device's WiFi or cellular connection to activate a push message that will activate the device and notify the user of a particular event or redemption opportunity based on the mobile unit's geographic location or proximity to a product seller or provider.

The communication system herein employs a computer-assisted method based on software modules that manage the processing of pre-existing customer data and a single lender-initiated credit pre-screen to extend pre-approved multi-product, cross-category suites of offers, eliminating any need for a traditional customer-initiated loan application. One significant enhancement in the patented system is that the system does not process user-initiated loan applications because the system implements pre-approved offers are lender-initiated, meaning that the credit check (pre-screen) has been initiated and performed by the lender financial institution without the knowledge or pre-request of the customer. The customer never actually is required to submit a loan application as they are simply approved for the loan, and can accept it instantly without any need for further evaluation.

Pre-approved loan offers are “offers that have been approved by the financial institution and can be funded and fulfilled by a financial institution on a real-time, immediate basis without the need for further application processing and approvals by the financial institution.” Funding and fulfillment of the pre-approved loan can be accomplished “on-demand,” which also means that they “can be funded and fulfilled by a financial institution on an immediate basis without the need for further application processing and approvals by the financial institution.”

A client or customer that receives a pre-approved offer can access the benefits of a loan product over the system, which may be accessed on mobile or network based computers, on an on-demand basis, which means they can receive funding, with a simple acceptance/redemption from the client and fulfillment of the loan offer by the financial institution. By “on-demand” acceptance, the invention supports the fulfillment and funding of the pre-approved loan offer after the demand is sent by the customer through their acceptance and redemption of the loan offer.

The present invention is used by financial institutions, insurance providers, and other companies which want to offer pre-approved products or services to a customer or customer base as to which customer data is available. The accessed customer data can be used to determine the nature of the financial offer that the company wishes to extend. A portion of the customer data will likely reside in the company's own databases and thus the system is advantageous for use by companies that want to market offers to their pre-existing customers. Another portion of the customer data will likely reside in outside sources such as credit bureaus. It is envisioned however, that in some cases the customer data can reside in total in outside sources. While the system of the invention will be referred to with respect to the offering of financial products, even though it should be understood that other products can be offered as well, such as using another variation of this programming logic and software to create customized multi-product insurance offers as well.

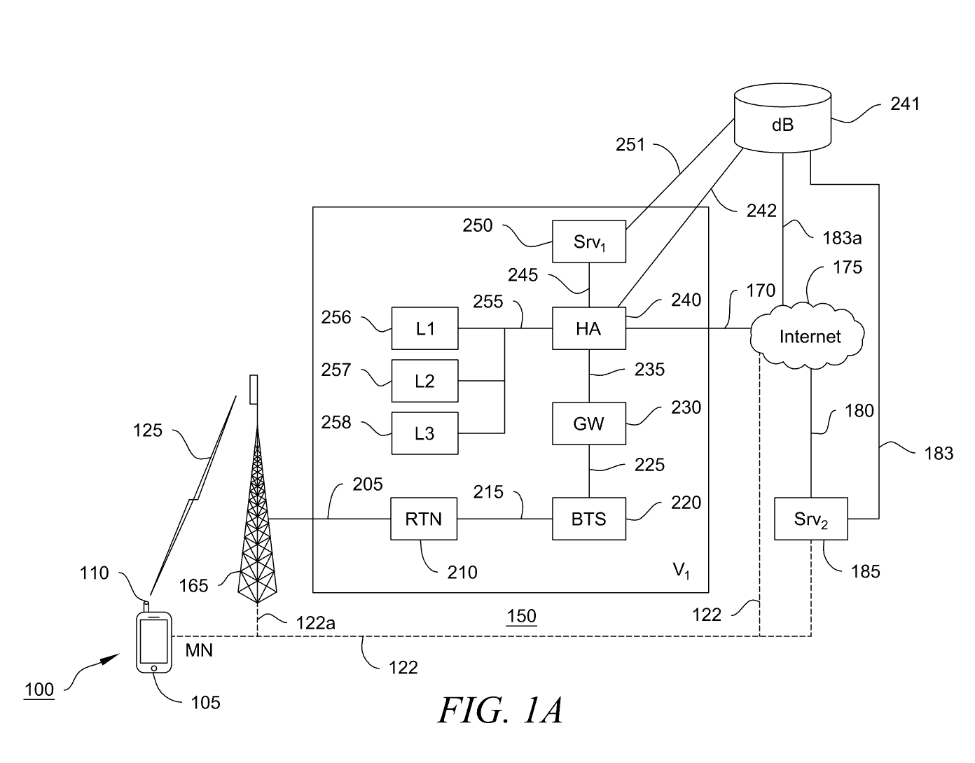

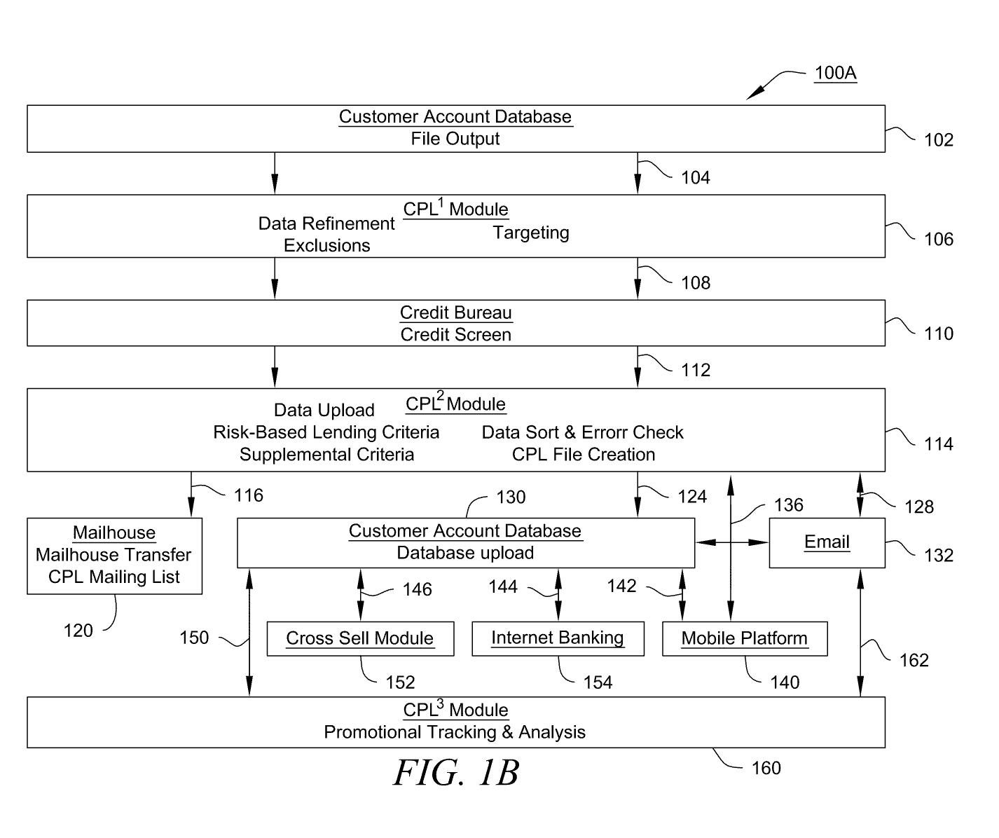

With reference of FIG. 1A, the communication system of the present invention is shown with a detailed explanation of the system components available at the home network 150 as coupled via communication line 205 mobile radio transceiver/cellular/WIFI systems 165 coupled to mobile node 100. The mobile node 100 includes a hand-held mobile unit 105 that includes a processor, memory and a power source, as well as a transceiver and antenna 110. While a mobile unit is contemplated, lap top, fixed location computers, or computer pads can also be used instead and freely substituted with the mobile unit 100.

The transceiver and antenna 110 supports radio transmission communications link 125 to an radio transceiver antenna and transmission network 165 (e.g. WiFi, cellular, GSM, Evdo, 4G/LTE, CDMA, or others), which is coupled via connection 205 to a radio transmission network communication gateway 210 associated with the home network 150. The mobile hand-held unit 105 may also be connected to an outside server computer SRV2 185 via a separate connection 122, which can include a wireless radio connection or a wireline communication system connection. The mobile hand-held unit 105 may also be connected to the Internet 175 via the communication link 180 through outside server computer SRV2 185 or via a separate direct connection 122, which can include a wireless radio connection or a wireline communication system connection. The mobile hand-held unit 105 can also be coupled to the radio transceiver antenna 165 and a radio transmission network that is coupled to a telecommunications system that supports connectivity 122a to the Internet 175 or another system network without interfacing directly with equipment or components in the home network 150.

The radio transmission network 210 is coupled to a base station transceiver unit 220 via connection 215, where the base station transceiver station provides an interface between radio domain communications and data communications carried over a telecommunications or network computer system. The base station transceiver unit 220 is coupled to a gateway 230 for the network at the home network 150 via connection 225, which provides an interface with the network maintained at the home network 150 or associated with the home network 150. The BTS 220 may also be located remotely from the home network near the remote radio transmission network 165 accessed by the mobile unit 100.

The gateway 230 is coupled to a home agent 240 via connection 235, where the home agent 240 controls communication flow and directions on the network maintained at the home network 150 or in a network associated with the home network 150. The home agent 240 is coupled to a computer server SRV1 250 via connection 245, which maintains past historical and present real-time information, software module, operations software, or other data that may be used or communicated using the invention. The invention contemplates centrally located servers to maintain the software modules and database information at the home network 150 that maintain or provide access to information related to the home network 150, but remotely located servers and computer networks can also be accessed and used with the invention.

The home agent 240 is coupled to the Internet 175 via a connection 170, and the Internet 175 may be coupled to one or more servers SRV2 185 via connection 180. The mobile hand-held unit 105 may also be connected to SRV2 185 via a separate connection 122, which can include a wireless radio connection or a wireline communication system connection. A database 241 is coupled to the home agent 240 via communication link 242 or computer server 250 via link 251 or computer server SrV2 185 directly via link 183 or indirectly through the Internet 175 via communication links 183a and 180. The database 241 may maintain information related to the customers of the financial institution, but it could also maintain remote access to software modules and database information used with the software operated by the present invention as well as database information related product inventory, sales information, VIN or other scan information, location specific information or other information used with the invention. While only one database 241 is shown, this representation is understood to include one or more separate databases and storage locations of data and information.

The home agent is also coupled via connection 255 to various locations L1 256, L2 257, and L3 258 at home network 150 so that operations software and data can be entered into the system and controlled by users at those locations. Users and controllers at the bank or financial institution's locations may also access the home network 150 remotely via communication links and wireless communication links or mobile units. Communications to the system and requests for information from remote access locations or hand-held mobile unit 100 can be processed at the home network location 150. These requests for information include the transmission of customer information and applications, credit information, pre-approval certifications, pre-approval offers, redemption of offers, and adjustment of customer offers based on fulfillment and payment of an accepted pre-approved offer by a customer.

The computer server SrV1 250 on the home network 150 supports the maintenance and use of data, customer information, software modules and operational code for the present invention, as well as maintaining the webpages that support the applications program download for the present invention, and supporting the interaction of communications with the mobile unit 100 and database 241. The Internet 175 can also maintain server computers, cloud storage, or server for maintaining database information, code, software modules, or the webpages that support the applications program download for the present invention, as well as supporting the interaction of communications with the mobile unit 100 or database 241. Furthermore, or the computer server SRV2 185 can also facilitate or assist with the maintenance of database information, code, software modules, or the webpages that support the applications program download for the present invention, as well as supporting the interaction of communications with the mobile unit 100 or database 241.

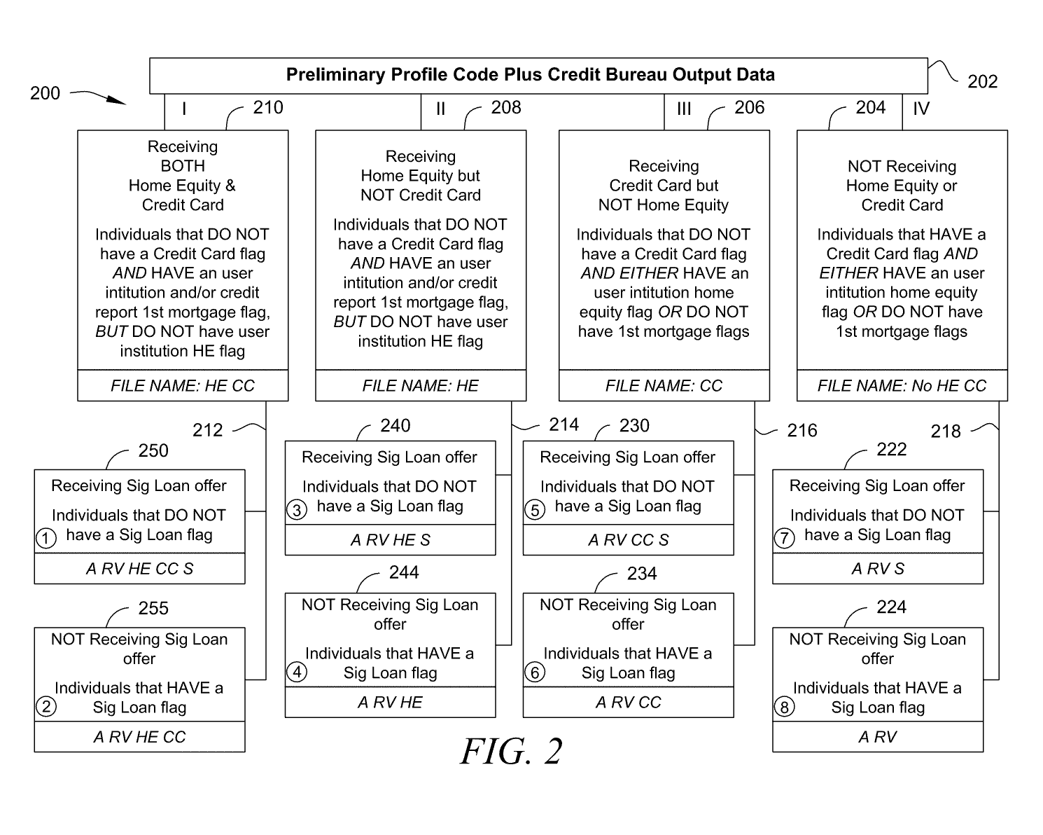

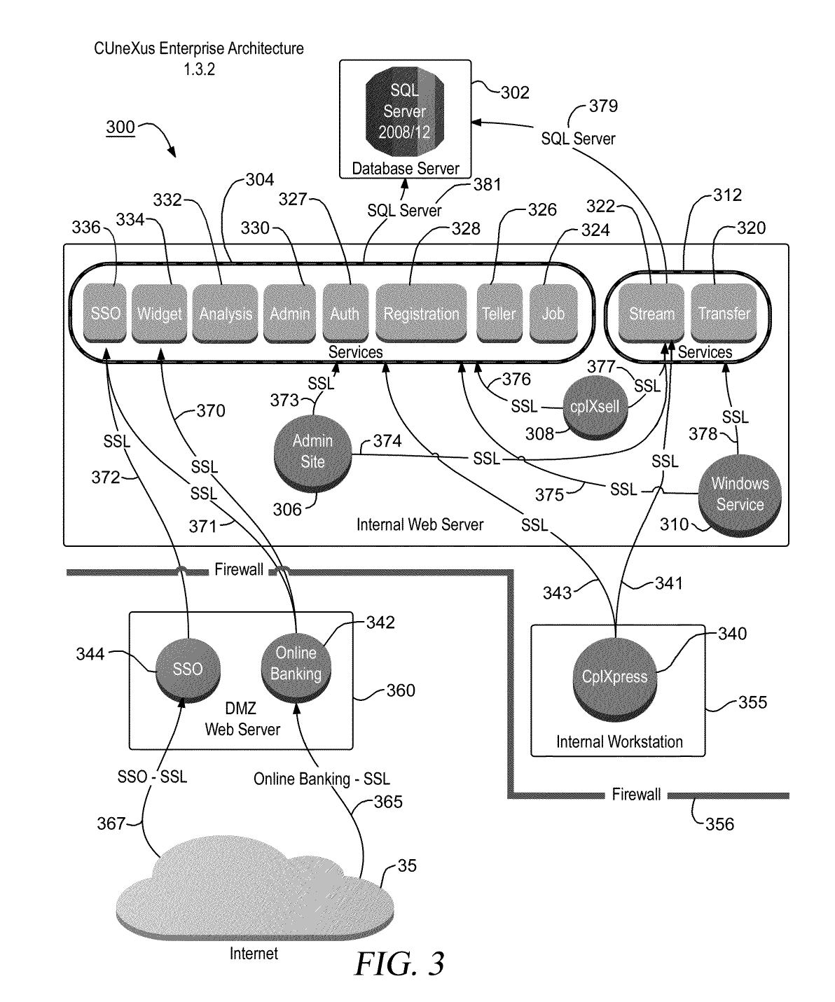

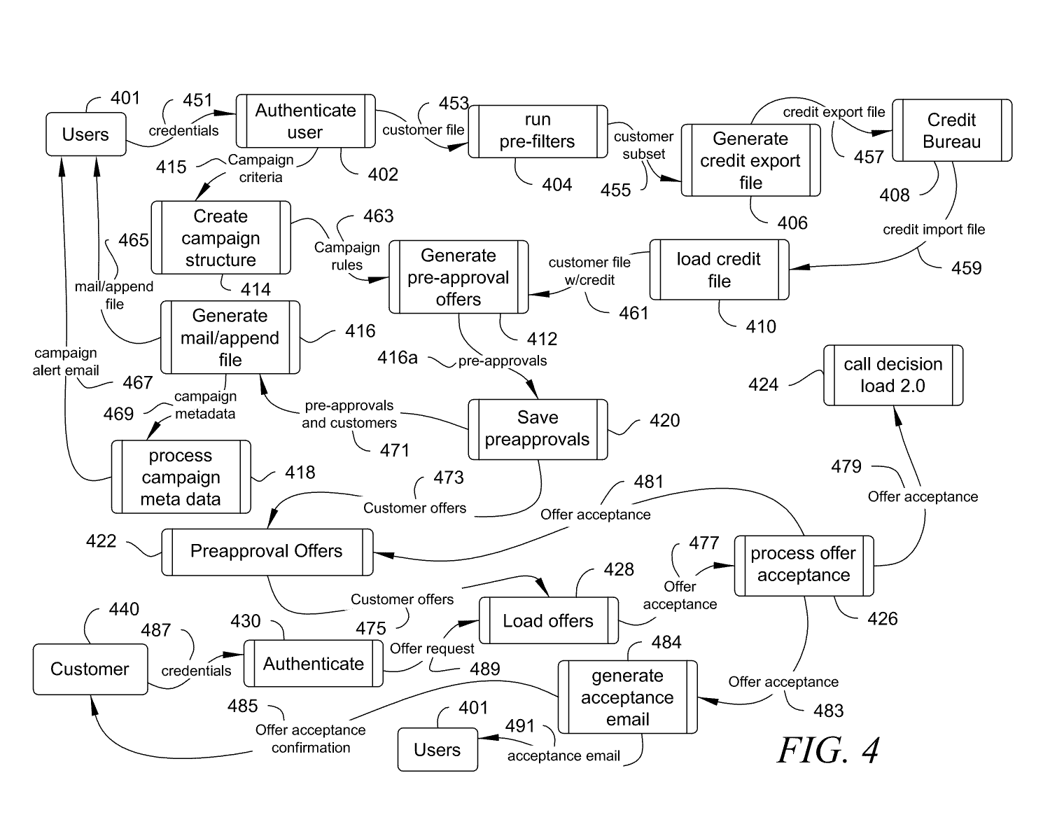

The software modules shown in FIG. 1-2, the message flow in FIG. 4 on the computer system and home network 150 shown in FIG. 1A and FIG. 3 supports the processing of communications to and from a mobile unit 100, including a method of processing data from a database 241, evaluating customer information, providing pre-approved offers to customers, fulfilling accepted pre-approved offers, updating the system and database information to reflect fulfilled offers by customers. Using software modules shown in FIG. 1-2, the message flow in FIG. 4 on the computer system and home network 150 shown in FIG. 1A and FIG. 3, the present invention also support processing of information transmissions the include geographic and location specific information and data relating to location of the mobile unit 100.

The software modules shown in FIG. 1-2, the message flow in FIG. 4 on the computer system and home network 150 shown in FIG. 1A and FIG. 3 supports the following functionality based on its software modules, database information, communications interface software and webpages, such as: (1) customer evaluation and pre-approval for multiple varied product suite; (2) database retention of pre-approved customers; (3) determination of which loan products get approved and how much is approved for each product; (4) communication of pre-approved product suite of different types of loan products to customers; (5) fulfillment and funding of on-demand acceptance of pre-approved offer; (6) updating system after fulfillment of accepted pre-approved offer by customer; (7) geo-targeting of customers of pre-approved offers; (8) push notices to customers at opportune timing to deliver up to date pre-approved offer to customer at the opportune moment; (9) valuation bar and database access products that are being shopped by customer; (10) approved and guaranteed pricing for shopped items; (11) real-time local product or service inventory database access; (12) calculator regarding monthly payments at predetermined interest rates with an input down payment amount; (13) product code scanner recognition (e.g. VIN code, bar code); and, (14) loan document generation/signature capture.

The present invention defined by the software modules shown in FIG. 1-2, the message flow in FIG. 4 on the computer system and home network 150 shown in FIG. 1A and FIG. 3 preferably provides functionality for generating variable pre-approval decisions for different products in the user-defined suite. A series of matrices are utilized to create customized product offers, based on each individual customer's unique product relationship with the lending institution and several pieces of information provided within their credit report as is further detailed below. In addition to customer identification information, the unique product relationship with the user institution is noted. In a preferred embodiment, a secure file transfer protocol (FTP) data transmittal interface is provided which assists in securing any data that is transmitted from the user institution to an outside vendor.

The software modules and system software is programmed in an application software that can be/is utilized by the hand held or portable devices in whatever programming language the said device utilizes to operate the applications and then utilizes the wireless communication networks(s) available to that device in that area or any other area where the mobile unit 100 can operate in using the functions and/or features of present system. An applications program is downloaded to the hand-held mobile unit 100 that supports an interface with home computer network 100, and the mobile unit will have access to multiple functions and features identified above relating to the present invention. In the present invention, the mobile unit can include a mobile phone, smartphone device, or portable computer having a wireless radio transmission connection to the home network 150. (e.g. iPhone, Droid, iPad, Slate, etc.).

The software packages residing and operating on the home network 150, preferably the computer server SrV1 250 on the home network 150 and the mobile unit 100, is a universally exportable and importable data format preferably employed so that data from the financial institution's core processing system can be collected and maintained on database 241 in a form that can be recognized by the stand alone software package of the invention. A preferred universally exportable and importable data format such as a text file for example txt. This format is commonly used in business and therefore providing software that can import data from this format for further analysis is cost-efficient and convenient. The software may also be provided with the capability to import data in other formats generated by the core processing unit.

With regard to FIG. 1, the software modules 100A are shown with the customer account database 102 providing a file output on link 104 to the CPL1 module 106, which performs a data refinement, exclusions and targeting of possible customers that can receive pre-approved offers of multiple different types of product in a product suite offered by the financial institution. The CPL2 module 106 communicates with the credit bureau 110 on link 108, which provides information to a CPL module 114 on link 112 to perform data upload, risk-based lending criteria analysis, supplement criteria analysis, data sorts and error checks and CPL File creations that is transferred to the Customer Account Database 130 on link 124. The CPL File may also be transferred from the CPL2 Module 114 to the Mailhouse 120 on link 116 to support a mailhouse transfer of the CPL mailing list.

The Database, preferably database 241 in FIG. 1A, can be uploaded to or correlated with the Customer Account Database 130, which is used to: (1) support the Cross Sell Module 152 operations linked by communication link 146, (2) support the Internet Banking Module 154 operations linked by communication link 144, (3) support the Mobile Platform 140 operations linked by communication link 142, (4) and the CPL3 Module 160 promotional tracking and analysis operations linked by communication link 150. Email 132 operations are also linked the CPL2 Module 114 by link 136 or 128, the Customer Account Database 130 by link 136, the CPL3 Module 160 by link 162, and the Mobile Platform 140 operations by link 136.

The Preliminary Profile Codes 200 are generated using the software module operations shown in FIG. 2 starting at step 200, which proceeds to step 210 for individual that do not have credit flag and receive both home equity and credit card credit offers, to step 208 for individuals that do not have a credit flag and receive only home equity offers, to step 206 for individual that do not have a credit flag and receive only a credit card offer, and step 204 for individuals not receiving any offers. From step 210, the program proceeds along link 212 to step 250 for individuals that do not have a signature loan flag and will receive a signature loan offer or step 255 for individuals that have a signature loan flag and will not receive a signature loan offer.

From step 208, the program proceeds along link 214 to step 240 for individuals that do not have a signature loan flag and will receive a signature loan offer or step 244 for individuals that have a signature loan flag and will not receive a signature loan offer. From step 206, the program proceeds along link 216 to step 230 for individuals that do not have a signature loan flag and will receive a signature loan offer or step 234 for individuals that have a signature loan flag and will not receive a signature loan offer. From step 204, the program proceeds along link 218 to step 222 for individuals that do not have a signature loan flag and will receive a signature loan offer or step 224 for individuals that have a signature loan flag and will not receive a signature loan offer. Flags include events in the customer's history or the acceptance of a pre-existing financial product from the suite of multiple different products offered by the financial institution.

Referring to FIG. 2, a flowchart showing how the final profile codes are created. The final profile code may be created according to different criteria and is not limited to the example shown in FIG. 2. Each preliminary profile code with the appended credit bureau data is sorted by the offers each profile may or may not obtain. This is typically done by the software program. For example, Pathway III illustrated in FIG. 2 represents the logic employed as to customers that already have a home equity loan, but not a credit card. The customers are then divided into (Box 5) those that will receive offers for signature loans and (Box 6) those that will not. Once the sorting is done, each cluster of final profile codes, having similar offer types, is given a final profile code number for future processing.

In FIG. 2, the box number is also the final profile code number. The offers associated with the final profile number 6 are auto, recreational vehicle/boat/motorcycle/etc, and credit card. Along the bottom edge of each numbered box, abbreviations for the offers of each group are shown. A represents auto, RV represents recreational vehicle, boat, motorcycle, etc, HE represents home equity loan and home equity line of credit, CC represents credit card, and S represents a signature/personal/debt consolidation loan. The invention may allow for availability of more or less offers and is not limited to the examples disclosed.

The system will also preferably provide for a user-defined default set of offer(s) that customers will receive if not placed within a group. For example, Box 8 in FIG. 2 represents the default for the given example scenario. According to this example, each customer for whom data is requested from a credit bureau will at least receive offers for an auto and a type of recreational vehicle. This functionality is provided by the system to assist the user institution in complying with applicable laws and regulations which may require that an individual must be offered some form of product if a credit search is performed.

One of the advantages of the system in this regard is that it analyzes all products that it has available and can provide multi-product offers to customers. This functionality allows the user institution to minimize the number of default offers it may have to send to comply with applicable laws and regulations. By using the system of the invention with this functionality, the user institution need only communicate one default offer. Previous methods required user institutions to send a default offers every time the customer was not suitable for the single-product offer intended. It should be noted that the default offer(s) is/are defined by the user institution and not limited to the example given.

Each customer is then passed through a tier structure with user-defined criteria. The user institution defined risk-based lending criteria for each product being offered which has been entered into the system utilizes tiered rate structure templates. Each final profile code is compared with the lending criterion and customized variable product combinations are generated to be offered to each customer. Examples of products that may be offered via CPL include, but are not limited to: new & used auto, recreational vehicle, boat, motorcycle and aircraft loans, home equity loans and lines of credit, credit cards, unsecured loans and lines of credit, student loans, mortgage loans, overdraft lines of credit, debt consolidation loans, small business loans, etc.

Table 1 shows an example of the tier system used by the system software. Each group, range, and/or amount is defined by the user, for example, Table 1 shows chosen credit score ranges of every ten to define each group. Each group is then related to certain percentages and amounts for given offers also defined by the user. Each profile code group is passed through this tier structure. As the profile codes pass through the tier structure, each customer profile is associated with a certain group or range according to the data found in the credit bureau data and/or customer data. The user-defined percentages and amounts are then collected for the respected offers within that group or range. At this point in the process, each customer profile is personalized to each customer by the types of offers they will receive and the amounts and interest rates contained in those offers.

TABLE 1
Example Tier Structure of User-Defined Criteria

| Beacon Score 640-659 | Beacon Score 660-669 | Beacon Score 670-679 |
|---|---|---|
| Auto Loan Amount: | Auto Loan Amount: | Auto Loan Amount: |
| $20,000 | $20,000 | $25,000 |
| New Auto Loan APR: | New Auto Loan APR: | New Auto Loan APR: |
| 7.99% | 7.99% | 7.99% |
| Used Loan APR: 8.09% | Used Loan APR: 8.09% | Used Loan APR: 8.09% |
| RV Loan Amount: $20,000 | RV Loan Amount: $20,000 | RV Loan Amount: $25,000 |
| RV APR: 8.74% | RV APR: 8.74% | RV APR: 8.74% |
| Credit Card Amount: $2,500 | Credit Card Amount: $2,500 | Credit Card Amount: $7,500 |
| Credit Card Classic | Credit Card Classic | Credit Card Classic |
| Introductory APR: 16.90% | Introductory APR: 16.90% | Introductory APR: 7.90% |
| Credit Card Classic | Credit Card Classic | Credit Card Classic |
| Standard APR: 16.90% | Standard APR: 16.90% | Standard APR: 13.90% |
| Signature Loan Amount: | Signature Loan Amount: | Signature Loan Amount: |
| $2,500 | $2,500 | $5,000 |
| Signature Loan APR: | Signature Loan APR: | Signature Loan APR: |
| 16.99% | 16.99% | 14.99% |
| Home Equity Loan Amount: | Home Equity Loan Amount: | Home Equity Loan Amount: |
| $0 | $75,000 | $75,000 |
| HELOC Loan APR: | HELOC Loan APR: 7.250% | HELOC Loan APR: 7.250% |
| N/A | Start Rate | Start Rate |
| Fixed Rate 2nd APR: | Fixed Rate 2nd APR: | Fixed Rate 2nd APR: |
| N/A | 8.375% | 8.375% |

The Enterprise Architecture 300 block diagram of the present invention is shown in FIG. 3 where the SQL Server 2008/12 302 (preferably computer server SvR1 250 from FIG. 1) is located on the system as the database server. The SQL Server 302 is coupled to the Services 304 operations via link 381 and the Stream operations module 322 via link 379, which is located in the Services 312 operations with the Transfer operations module 320. The Services 302 operations includes the SSO module 336, Widget module 334, Analytics module 332, Administration module 330, Authentication module 327, Registration module 328, Teller module 326, and the Job module 324.

The Windows service module 310 is coupled to the Services 304 module and the Services 312 modules via links 375 and 378, respectively. The CplXsell module 308 is coupled to the Services 304 module and the Services 312 modules via links 376 and 377, respectively. The Admin Site module 306 is coupled is coupled to the Services 304 module and the Services 312 modules via links 373 and 374, respectively. And the CplXpress Internal workstation module 355 (which includes a CplXpress Internal workstation 340 corresponding to the L1 256, L2 257, L3 258 modules in home network 150 of FIG. 1) is coupled to the Services 304 module and the Services 312 modules via links 343 and 341, respectively. The SQL Server 2008/12 302, Windows module 304, Windows module 312, Admin Site module 306, CplXsell module 308, Windows Service module 310 and the CplXpress module 355 are all located internal to the home network 150 on the inside of a secure firewall 356.

Outside the firewall 356, the DMZ Web server 360 (which has the SSO module 344 and the Online Banking module 342) is located and coupled through the secure firewall 356 to the SSO module 336 and the Widget Module 334, respectively, along links 372, 371 and 370. The SSO module 344 and the Online Banking module 342 are coupled to the Internet 35 along links 367 and 365, respectively.

The process workflow for the present invention is shown in FIG. 4, where Users 401 proceeds to Authenticate User step 402 on message 451, then onto Run Pre-Filters on message 453, and a subset of customers are loaded onto a Generate Export File 406 on message 455, which is exported to a Credit Bureau step along message 457. From the Credit Bureau step 408, the flow proceeds to the Load Credit File 410 on message 459, which proceeds to the Generate Pre-Approval Offers step along message 461. This step can also be reached after step 402, which can also proceed to the Create Campaign Criteria step 414 along message 415, which proceeds to the Generate Pre-Approval Offers 412 along message 463.

Once the Pre-Approval Offers are generated in step 412, the procedures flow to the Save Pre-Approvals step 420 along message 416A, which proceeds to Pre-Approval Offers Step 422 along message 473 or the Generate Mail/Append File step 416 along message 471 (which proceeds back to the start at Users step 410 along message 465 or the Process Campaign Meta Data step 468 along message 469, which then proceeds back to the start at Users step 410 along message 467).

From Preapproval Offers step 412, the process proceeds to the Load Offers step 428 along message 475, which proceeds to the Process Offer Acceptance step 426 along message 477. From that Process Offer Acceptance step 426, the workflow can proceed to the Call Decision step 424 along message 479, the Generate Acceptance Email step 484 along message 483, or back to the Pre-Approval Offers step 422 along message 481. From the Generate Acceptance Email step 484, the process workflow can proceed to the Users step 401 via the acceptance email message 491 or to the Customer step 440 along message 485. After the Customer step 440, the process flow proceeds to the Authentication step 430 along message 487, which proceeds to the Load Offers step 428 along message 489.

The present invention defined by its operations in the software modules shown in FIG. 1-2, the message flow in FIG. 4 on the computer system and home network 150 shown in FIG. 1A and FIG. 3 evaluates customer criteria, and criteria as to what characteristics a customer must have to be extended particular offers are generally set by the company making the offer. For example, offers as to financial products such as loans, credit cards, mortgages, insurance and the like can benefit from the system of the invention. The criteria set internally by the financial institution may involve the types of loans it has decided to make available from its institution, for example home mortgages, auto loans and boat loans. One of the criteria is generally the credit-worthiness of the customer which is often referred to as the credit score of the customer. The credit score may and generally does reside in outside sources such as credit bureaus.

The system of the invention provides an evaluation and analysis of customer data from internal company sources and correlates it with any data obtained from outside sources, such as credit bureaus. After the analysis is accomplished, the system is able to provide customized offers to customers that are based on the company-set criteria and the company's products. Further, the system provides for communication of the customized offers to the customer. In addition, the system provides for reassessment of the offers not accepted by the customer upon acceptance of one or more offers, generation of new offers, and tracking of offers accepted by the customer.

The system of the invention increases the response rate by customers, and it increases the return on investment (ROI) for the user institutions that employ it and reduces man-hours needed to make a determination as to the nature of the offers customers should be provided. The system is suitable for use by all user institutions, e.g. lenders, but is especially suitable for small and mid-sized lenders who may not have the resources and/or man power to implement effective pre-screened lending programs. In a preferred embodiment, the system further provides a functionality which allows the user institution to monitor customer acceptance of offers and/or to redetermine the nature of offers provided to customers in real-time. The present invention possesses technology to assist lenders in the evaluation of consumers, but such technology also can be used to support tools that automate underwriting and risk-based lending procedures.

This functionality may be known as a real-time results tracking and report generator. In another preferred embodiment, the system comprises an interface between the system and user institution departments such as loan fulfillment and/or retail and phone centers. This interface allows the user institution to more effectively cross-sell its products due to receiving real time data concerning customer interests and customer profiles and to fund loans promptly.

The system provides tools to effectively customize the nature of the financial product(s) offered to particular recipients, to increase the size of the group that lenders are able to contact with per unit amount as compared to prior methods, to provide the lender with cross-selling marketing capabilities and to provide the lender with the means to utilize on-line and wireless channels for example mobile communication devices, email, online banking, etc.

The system is able to increase the size of the customer base contacted as compared with prior methods. The system may result in cost savings over prior manual or semi-manual methods, and these savings can be reallocated to enable the financial institution to extend the combined offers to a much larger audience, for example the lender's entire customer base, thus realizing greater marketing and promotion per unit amount expended.

Further, multi-product promotion enabled by the system has a number of advantages. Customers are offered various products, increasing the chances that one of the products meets their needs at a particular time. Promotions can be offered on a continuous basis, so that customers can access pre-approved loans at any given time. The financial institution benefits in that these continuous offers position the institution as their customer's “lender-of-choice.” Separate loan applications are unnecessary as to the pre-approved products, as the lender's entire suite of loan products are available to pre-approved individuals at an on-demand, or nearly on-demand, basis. User financial institutions can offer their clients the convenience of remaining pre-approved for an array of offers at all times.

In a preferred embodiment, the system of the invention is implemented by a software module which is or can be loaded into a computer system and which software enables a method that can be carried out continuously. In such an embodiment, all results of the individual data derivation steps or correlations are communicated electronically to a subsequent processing step up to the time of communication of the offer to the customer. One embodiment comprises a stand alone software package which may be loaded on the mobile unit as well as the home agent network. The computer on which the software is loaded can be in electronic communication with the user institution's core processing system and may receive data there from through the communications means between the computers. Alternatively, data from the core processing system may be transferred to an intermediate source, such as a data reception site or a memory storage device, then to the stand alone computer.

In utilizing the system of the invention, the user financial institution can pre-screen a customer and determine appropriate offers to extend to a customer regarding a user-designated suite of financial products. The user-designated suite of financial products preferably contains all of the products offered to any of its customers. The user-designated suite may for example include products that heretofore rarely or never were promoted via pre-approval. The system provides functionality to determine offers for all customers in the user database, or a subset of customers defined as being of interest by the user, as to all products in the user-defined suite in a single process.

### Customer Evaluation

Customer Evaluation is first handled through the Pre-Filter step in building out a campaign in the software platform. The financial institution imports as many of their customers as they wish to evaluate in TXT or CSV format (Customer Input File). Once the customers are uploaded, the Pre-Filter functionality is used to evaluate the customers to see if they should be considered in the pre-approval campaign. The pre-filter tab allows the Financial Institution (FI) to specify who should be included and/or excluded based on factors such as customer age, tenure, geographic region, branch, consumer segment, warning codes, debt to income ratio, and things of the like.

At this point, all customers who have made it through the pre-filtering process are either electronically transmitted directly, or exported from the software in one of several pre-formatted TXT or CSV file formats (Credit Bureau Export File), and then sent to any of the three major credit bureaus for pre-screening (credit check). The FI works with the credit bureau directly to determine their desired minimum credit qualifications for their “default product(s).” The credit bureau analyzes the customers present in the Credit Bureau Export File, then returns a list of all customers who have met their minimum credit criteria either in a pre-formatted TXT or CSV file (the Credit Prescreen File), or directly into the software via electronic transmission.

This file contains (a) the names of all customers who have met the minimum requirement, and (b) any number of additional data points and credit attributes needed in order to complete the offer assignment process within the software (i.e. credit score, debt-to-income score, income, open account types and balances with other creditors, etc). Upon import of the Credit Prescreen File, the software matches and appends all previous customer records with their individual credit bureau data. Any customers that did not meet the minimum prescreen criteria, and are therefore not present in the Credit Prescreen File, are discarded by the system. The remaining customers are then further evaluated using one or more of the following analytical steps.

Between the Customer Input File and the Credit Prescreen File, the system has all of the data necessary to evaluate each customer and assign relevant pre-approved offers (firm offers of credit). Preapproval of multiple varied product suite is next handled through the Products step in building out a campaign. In this area the FI specifies which products are to be considered for the customer base that was included in the campaign. They can offer as many products as they wish and use system intelligence to determine which customers will be offered which products. This is done through Relationship Rules.

Relationship Rules are configured separately for each product to be offered in the campaign. These rules look at the product relationships that the customer has with the FI, as well as any other information known about each customer (i.e. account balances, behavior, tenure) in order to make an intelligent and/or relevant offering. A simple Relationship Rule might state that if a customer does not own a home, do not offer a home equity loan. A more complex Relationship rule might state that if a customer has been with the FI for more than 2 years, does not have a credit card with the FI, has never defaulted on a loan, and logs into online banking at least twice per month, offer them a Visa. The data utilized in Relationship Rules is imported into the software from one or more sources, including, but not limited to the FI's Core Processing System (customer account database), MCIF, Credit Bureau(s), and other internal and external data sources.

These components interact with each other every step of the way. Prior to being able to make an offering to a customer they must first be evaluated using the Pre-Filter tab to see if they should even be considered for an offer. Once the system knows that they should be considered, the full customer relationship must then be examined to determine which product offers they should receive.

Assuming an individual has passed through the Relationship Rule criteria for any one product offer, even further evaluation is made within the Tier structures. Tier structures are utilized to determine (a) if the customer's credit rating is high enough to qualify for the product offer, and if so, (b) what Annual Percentage Rate (APR) to offer, (c) their available credit limit, and (d) their available loan term options

### Database Retention of Information

The database of pre-approved customers (Customer Input File) is loaded into the software by using the Customers tab of the software. Typically, the customer data is obtained through export from either the FI's Core Processing System (customer account database) or from the FI's MCIF system. Then once the campaign is in effect all customers who are in the campaign are retained by the software for the duration of the campaign. While the campaign is in effect there are no updates to the customer database. At that point no one is added or removed from the database. So in that sense—there are no updates.

When a campaign ends—the FI can start up a new campaign, and introduce a new set of customers, which will then be retained for the length of the new campaign. It is up to the lender to determine the frequency of the updates, but current best practice is every 60-90 days.

### Determination of Approved Products

The FI establishes which products get approved by adding products into the software one at a time. They are free to offer as many products as they wish. This does not mean every customer will be approved for every product. That is determined by establishing Relationship Rules. These rules look at all facets of the individual customers. The software can consider things unique to the customer as an individual (age, zip code, income, salary, etc.) or things unique to the customer's relationship to the FI (tenure, products currently held, loan status, channel usage, etc.)

In order to determine how much is approved for each product and customer, the software makes use of Tiers and Sub-Tiers. These define specific criteria with regard to the credit worthiness of each customer. A Tier defines what the credit score range (Equifax, Transunion, or Experian) and loan term must be met in order to receive a specific pre-approval amount as well as a specific interest rate for that product. A Sub-Tier defines the rate and pre-approval amount (credit limit) for customers who fall into a specific Tier but desire a different loan term.

Example of a Tier: The FI can specify that if a customer has a credit score between 680 and 700, they qualify to receive an Auto Loan offer for 60 months at a rate of 3.99% APR, for up to $40,000.

Example of s Sub-Tier: In the event that the same customer above (credit score between 680 and 700) wishes to have a different Loan Term the FI can specify a different approval amount and interest rate. Perhaps the customer would prefer a 72 month term (instead of 60), now the FI can set the amount to only go up to $35,000 (instead of $40,000) at a rate 3.79% (instead of 3.99%).

### Communication of Pre-Approved Suite Offers

Once the determination has been made as to which product offers to assign to each customer, all of the offers are saved to the central SQL database, where they reside as “active” for the duration of the campaign.

Each communication channel (online banking, mobile banking, and cross-sales module for branch/call center) is tied to the SQL database in real-time, so that it can look up individual customers and customer offers and present them in the user interface for review and instant acceptance.

In the case of an online banking website or mobile banking app: upon customer login into the FI's online or mobile banking website/app, the SQL database is contacted and queried. The query returns the customer's personalized set of pre-approved offers (if any) and presents them within the user interface. The customer may then review the offer(s), read about them, and simply click the “Accept” button to accept an offer and activate the loan. Upon activation, the SQL database is (a) updated to reflect the proper Acceptance Rules, (b) the customer is presented with a confirmation message, (c) the FI is alerted that the offer has been redeemed via automated email, and (d) the loan request is loaded into the FI's Loan Origination System (LOS) either manually or via API for funding and fulfillment.

In the case of the cross-sales module (cplXsell): the FI's sales person interacts with the web-based cross sales module. The first step is to look up the customer in the system, which is done either by account number query or name query, at which point the SQL database is contacted and queried. The query returns the customer's personalized set of pre-approved offers (if any) and presents them within the user interface. The sales person may then review the offer(s), and if the sales person is successful in cross-selling a particular product, they simply click the “Accept” button to accept an offer and activate the loan. Upon activation, the SQL database is (a) updated to reflect the proper Acceptance Rules, (b) the system generates an automated alert email, and (c) the loan request is loaded into the FI's Loan Origination System (LOS) either manually or via API for funding and fulfillment.

In the case of the online and mobile landing pages: the customer is directed to a landing page URL, usually via direct mail or email communication. The communications include a unique code that is generated by the software. Upon visiting the landing page, the customer is prompted to enter their unique code, at which point the SQL database is contacted and queried. The query returns the customer's personalized set of pre-approved offers (if any) and presents them within the user interface. The customer may then review the offer(s), read about them, and simply click the “Accept” button to accept an offer and activate the loan. Upon activation, the SQL database is (a) updated to reflect the proper Acceptance Rules, (b) the customer is presented with a confirmation message, (c) the FI is alerted that the offer has been redeemed via automated email, and (d) the loan request is loaded into the FI's Loan Origination System (LOS) either manually or via API for funding and fulfillment.

Offers are also communicated to customers via direct mail. Once the offers have been generated within the software, the software exports a preformatted direct mail file in either CSV or TXT format. This file is utilized by the print and mailhouse to generate personalized direct mail communications, which include all of the proper loan offers and product disclosures. Typically, the letters direct the customer to redeem their offer(s) either (a) within online banking, (b) within mobile banking, (c) within a campaign landing page, (d) in the branch, or (d) by calling the FI.

Offers are also communicated to customers via email. Once the offers have been generated within the software, the software has the ability to export preformatted email files/lists in either CSV or TXT format. These files are utilized to generate personalized email communications, which include all of the proper loan offers and product disclosures. Typically, the emails direct the customer to redeem their offer(s) either (a) within online banking, (b) within mobile banking, (c) within a campaign landing page, (d) in the branch, or (d) by calling the FI.

### Fulfillment and Funding

Fulfillment and Funding is a two part process because these offers are 100% pre-approved, NO further customer analysis is required, and no second credit bureau check is performed. The credit check occurred previously. These offers are “firm offers of credit” under FCRA guidelines. This means that in most circumstances, when the “Accept” button is clicked, the lender is free to open the account and fund the loan with absolutely NO further customer analysis. However, while not required, in some cases the lender may choose to review certain items at the time of funding. This is optional.

The method(s) for actual account opening and funds transfer varies from FI to FI, depending on the Loan Origination Systems (LOS) used by each. However, in the most advanced applications, upon clicking the “Accept” button within any of the software's user interfaces, the SQL database is queried and the loan request is loaded into the FI's Loan Origination System (LOS) either manually or via API for funding and fulfillment. Certain loan origination systems allow for instant, automated account opening, activation and funds/card availability.

### Updates of Customer Status

Once a customer accepts one pre-approved offer, that information is immediately reflected throughout all of the FI's channels. That includes online banking, mobile banking, teller line, and call center. This is done instantly, in real time. In addition this may also have an impact on any other product offerings this customer was offered. The software gives the FI the ability to establish Acceptance Rules. Acceptance Rules specify how other remaining offers are affected when a customer accepts a particular offer. There are 2 ways to do this: One and done, or custom.

For the sake of this example let us consider a customer who receives an offer for a Used Auto Loan, a New Auto Loan, a Visa, a Personal Loan, and a 2nd mortgage. If the FI opts to set their campaign up with a one and done Acceptance Rule—If the customer accepts any one of these offers, all other offers are removed from the offering (no longer pre-approved). In essence the campaign is then over for that customer. On the other hand if the FI opts to use custom Acceptance Rules they may specify something like this:

If the customer accepts the New Auto loan the Used Auto loan offer is removed.

If the customer accepts the Used Auto loan the New Auto loan offer is removed.

If the customer accepts the Visa the Personal loan offer is removed.

If the customer accepts the Personal loan offer the Visa offer is removed.

### Geo Targeting

The geo fencing present in the credit concierge mobile iOS application allows for specific locations to have a geographical perimeter placed on a specific location or multiple locations. This perimeter is placed on a location based on the GPS coordinates specified for that location and is determined by a Google Places API request filtered by location type. Credit concierge uses the iOS cellular tower network to understand its location and relevance to geo fenced locations. Below outlines the specific geo-fencing logic.

The maximum API distance is 50,000 meters, but the suggested minimum iOS distance for region monitoring: 150 meters. The maximum monitored location regions per app: 20 regions. The Flow for when to request locations includes the following steps: (1) significant location change event received, (2) Previous queries to Google are retrieved from local database, (3) If no previous queries are within maximum Google API distance->QUERY GOOGLE, (4) Determine which previous query was closest to the current location (CLOSEST_QUERY), (5) From CLOSEST_QUERY, determine the closest locations (maximum number of monitored regions applies) to the current location (CLOSEST_LOCATIONS), (6) From CLOSEST_LOCATIONS, determine which location is the furthest from the current location (FURTHEST_CLOSEST), (7) If the distance between the center of CLOSEST_QUERY and the current location plus FURTHEST_CLOSEST is greater than the maximum Google distance, the circle of CLOSEST_LOCATIONS does NOT lie entirely inside the circle of CLOSEST_QUERY and therefore we may need to hit Google again, or supplement with other previously queried locations.

Some constraints and criteria associated with the geo-location functions are as follows: If there are only TWO previous queries to Google which lay within the maximum Google distance, then we don't have enough previous queries to cover our current location. If the current location does lay within a predetermined triangle, all the locations within the three circles are accounted for and ranked from closest to furthest and set the maximum number of monitored locations as regions. After calculations are made, all the locations are returned and ranked from closest to furthest and set the maximum number of monitored locations as regions.

### Push Notices

When a device with credit concierge loaded on it enters into a geo-fenced location and is inside the location for a predetermined period of time the application sends an alert notification to the device. The credit concierge application process is keep running in the background using the cell tower significant change process outlined by the apple push notification protocol. When a device changes cell towers it checks to see where its location is at. If that location is within a known geo-fenced location it will send an alert notification using the apple push notification service.

### Valuation Bars and Database Inventory Access

The system accesses a subroutine to pull true market value, MSRP, for a specific vehicle. When a vehicle is scanned using the credit concierge QR code scanner it finds that specific VIN ID and queries the subroutine api for relevant information on that vehicle. That information is presented in a visual slider bar control. The slider bar control gives the user the ability to slide the control left or

right increasing or decreasing the amount of money they want to accept in the loan offer, and calculating their estimated loan payment, based on their pre-approved loan rate and loan term.

### Pre-Approved Certified Pricing

The present invention performs a subroutine api to access Price Promise pre-negotiated pricing for inventory offered by a predetermined dealership network and available for consumption via the subroutine API. Upon authentication in the online banking widgets a user has the ability to shop for a vehicle from within a new or used car loan offer type. Once a user clicks the shop for vehicle button they are presented with automobile inventory available through the predetermined dealership network. Some inventory comes with a Price Promise attribute which has a pre-negotiated price for that specific vehicle.

### Dealer Inventory Access

When a consumer logs in to their financial institution's (FI) Online Banking or Mobile Banking platforms, they are presented with their pre-approved loan offers via Single-Sign-On (SSO) protocol from the software platform database. Offers are generated by the present invention, which is called in the market the CUneXus Solutions cplXpress platform. At login, the cplXpress platform calls out to a national database (i.e. edmunds.com) of auto dealerships and vehicle valuations. The cplXpress platform pushes the following information in that call: customer Zip code, make of any vehicle currently financed with the FI, Model of any vehicle currently financed with the FI.

Through the dealer database APIs, the dealer database returns inventory information for dealers within and proximate to the customer's zip code. Dealer inventory information returned to the cplXpress platform includes: Dealer Name, Dealer Address, Vehicle Make, Vehicle Model, Vehicle Photos, Vehicle Guaranteed Pricing (if applicable), Vehicle's True Market Value from predetermined subroutine, Trade-in Values on vehicles customer is currently financing with financial institution.

Within CUneXus's existing online banking interface, featuring the customers complete set of pre-approved loan offers, is the ability for customers to enter into the Auto Purchase workflow to view a presentment of these vehicles available from local dealers. The customer has the ability to modify their loan terms within certain parameters to filter the vehicle search, modify vehicle search information (make, model and/or year), search by zip code, and sort by dealer, year of vehicle and sale price.

The customer can also click on a link embedded in each vehicle description to receive additional vehicle and dealer location information contained with the edmunds.com vehicle database. The vehicle can then select the vehicle they are interested in purchasing and will be able to view the car's MSRP, True Market Value, and if available, the guaranteed dealer price.

Once continuing, the software interface will present Trade-In information to the customer. If the customer is already financing a car with the FI, the trade-in values for this vehicle(s) will be presented. The customer can also input another vehicle. The database will call out to the predetermined subroutine API and return trade-in values for that vehicle. At this time, the customer will again be able to modify their loan term and the software will calculate a new loan balance less trade-in and calculate a new monthly payment. Customer inputs or verifies their phone number and selects Finish. At this time the customer receives a closing message within a dialog box and is presented with the ability to print a certificate displaying the loan terms, vehicle purchase price, vehicle VIN, vehicle Price Promise ID (if applicable), and CU Direct Lending QR code (if applicable). The cplXpress database transmits a secure PDF of the loan redemption and vehicle purchase to the FI's loan department and the auto dealer notifying them of a redeemed offer.

### Down Payment, Monthly Payment Calculator

The CUneXus Solutions cplXpress platform automatically calculates and presents a monthly payment to the customer based on the loan amount requested, the term of the loan requested, and the Annual Percentage Rate (APR) the customer is pre-approved for. Available terms and associated APRs are provided by the FI and stored within the cplXpress database upon successful processing of a pre-approval campaign. Through online banking or mobile banking, the customer can request any loan amount up to the credit limit they are pre-approved for. The customer can select any loan term within parameters established by the FI and using the associated APR, the cplXpress software platform will calculate, based on an amortization table, the correct monthly loan payment.

The customer can also indicate any down payment they will be making. This amount is subtracted from the loan amount and a new monthly payment will be calculated and displayed to the customer. Down payment can be customer input or in the form of the trade-in value of another vehicle. The trade-in value can be derived by customer input or through access to a predetermined subroutine API.

### VIN Scanner

The cplXpress Vehicle Identification Number (VIN) scanner is a feature CUneXus Solutions' mobile banking application. The VIN scanner feature accesses the camera hardware of the customer's smartphone to take a picture of the VIN barcode present inside of a vehicle's driver side door or on the dashboard. Using barcode recognition the cplXpress mobile banking software sends the data to a third-party vehicle database. A make and model of the car is returned accompanied by the data requested by the application. The data requested is determined by the workflow and may include, but is not limited to: Vehicle True Market Value, Vehicle Price Promise Data, or Trade-In Value.

Data returned by a third-party (i.e. edmunds.com) is used as part of the loan acceptance workflow within the CUneXus Solutions mobile banking solution and is used to modify the final loan amount and monthly payment and to be presented to the customer to support their auto purchase decision.

### Loan Document Generation

With certain loan types, it is possible for us to further expedite the loan fulfillment process by generating final loan documents for review and signature. This occurs as follows: (1) Customer reviews loan offer in online or mobile interface and decides to accept, (2) They enter desired loan amount (up to their preapproved limit), (3) They select their desired loan term length from the options available, (4) They consent to e-signature, (5) They click the “Accept” button to redeem the offer, (6) At this point, the SQL data base is queried and returns all of the data required to pre-fill the variable fields on a formatted PDF loan document. The system also takes into consideration the requested loan amount, loan term, and rate in order to perform any/all of the calculations required to pre-fill certain variable fields on the PDF loan document. All of this occurs server-side, (7) The pre-filled PDF is then presented within the user interface for review and signature by the customer, (8) The customer signs the loan document in all required spaces. In a mobile smartphone environment, this occurs as a “sign on glass” interface, where the customer signs with their finger on the screen of the smartphone. In an online/desktop/laptop environment, this occurs in universally accepted and legally compliant methods for document e-signature, (9) Once the signature ceremony is complete, the PDF loan document is saved and archived within an electronic document repository, and/or loaded directly into the Loan Origination System (LOS), and/or transmitted to the FI via various electronic methods (i.e. email, api, ftp, etc), (10) At this point, the customer is now presented with options of where they would like their funds to be delivered/deposited (i.e. a checking account, savings account, paypal account, prepaid visa card, etc).

### Graphical User Interfaces

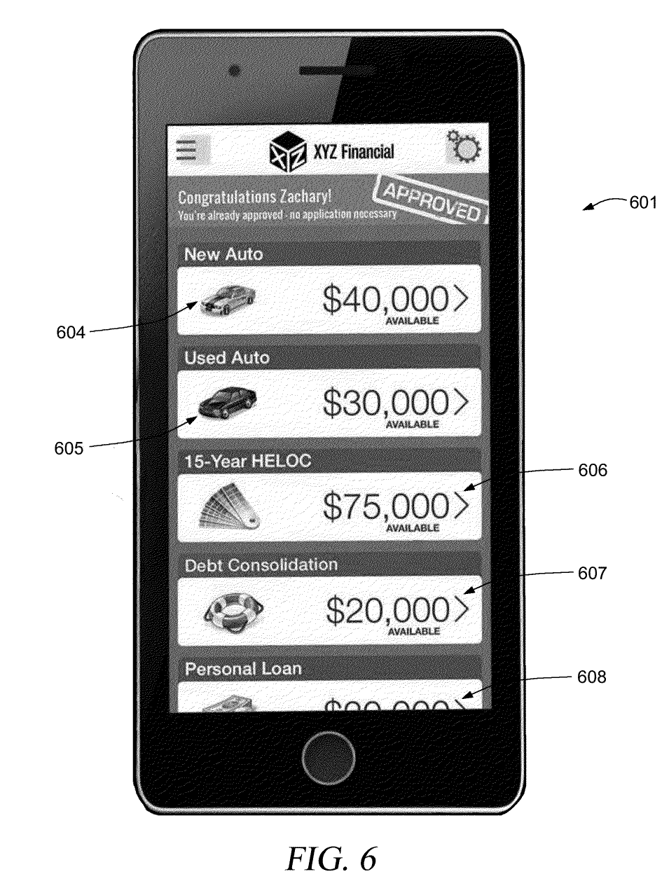

As shown in FIGS. 5-6, 7A-7E, 8A-8H, 9A-9M, and 10A-10J, the different graphical user interfaces for the mobile hand-held unit 100 are shown based on different parts and processing along the workflow of the current invention. FIG. 5 shows the three different screen formats supported by the invention with the multi-product suite of pre-approved products shown on the lap-top computer 501, the tablet 502, and the smart phone 502. The smart phone display of these pre-approved products is also shown in FIG. 6 on screen 601, which shows the multiple different pre-approved types of product, new auto loan 605, used auto loan 606, 15 year home mortgage 607, debt consolidation loan 608, personal loan 608—all preapproved by the financial institution and ready to be fulfilled “on demand.”

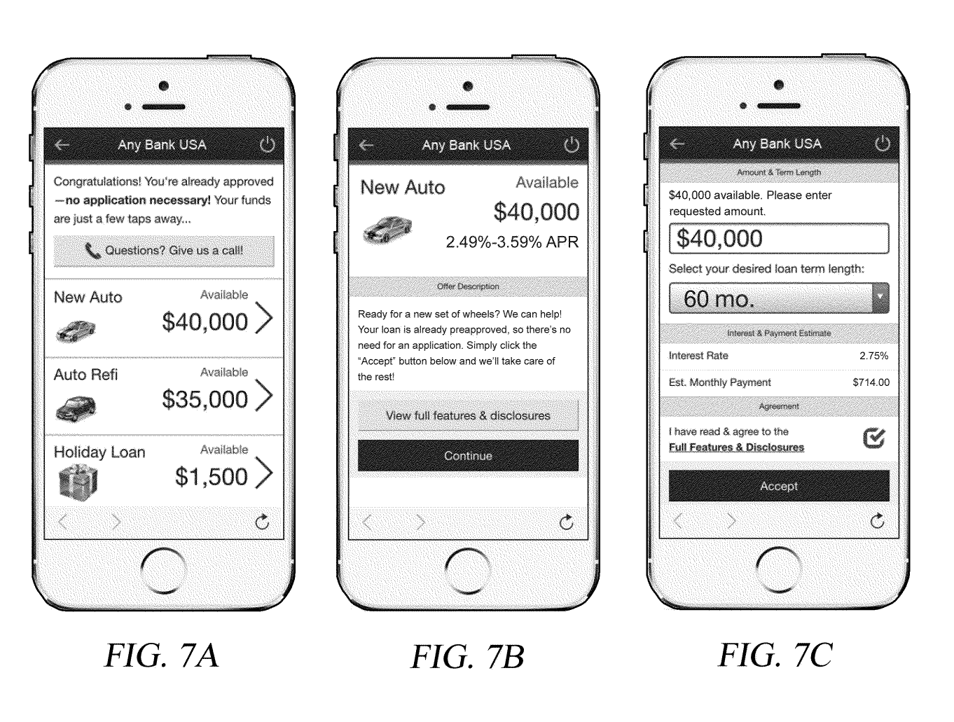

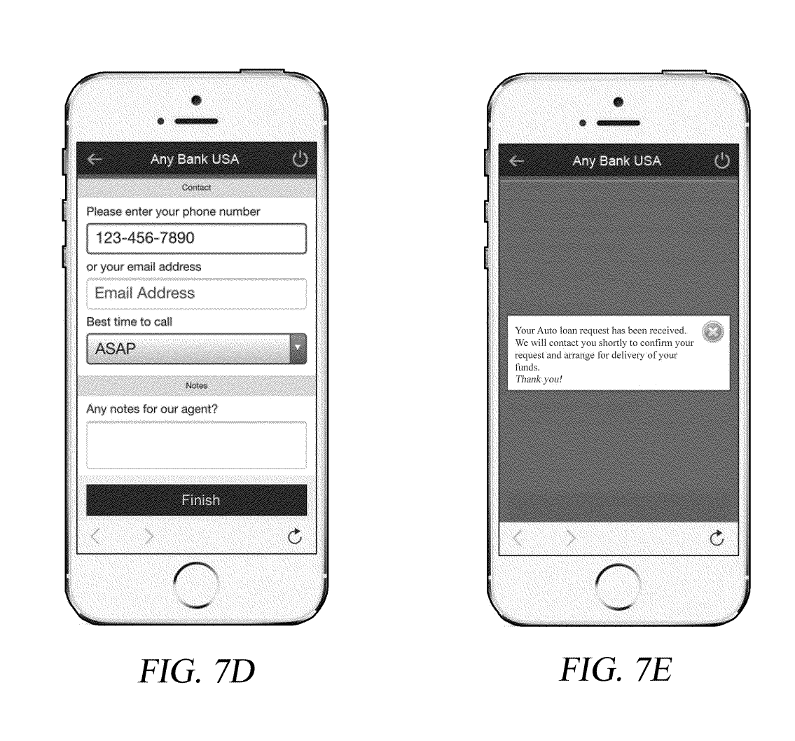

For FIGS. 7A to 7E, the screens for the mobile unit 100 show the pre-approved suite of products on FIG. 7A, the financial details of the new auto loan on FIG. 7B, the payment terms monthly for a given loan amount and interest rate in FIG. 7C, a contact information submission screen at FIG. 7D, and the receipt of loan request confirmation on the screen shown at FIG. 7E.

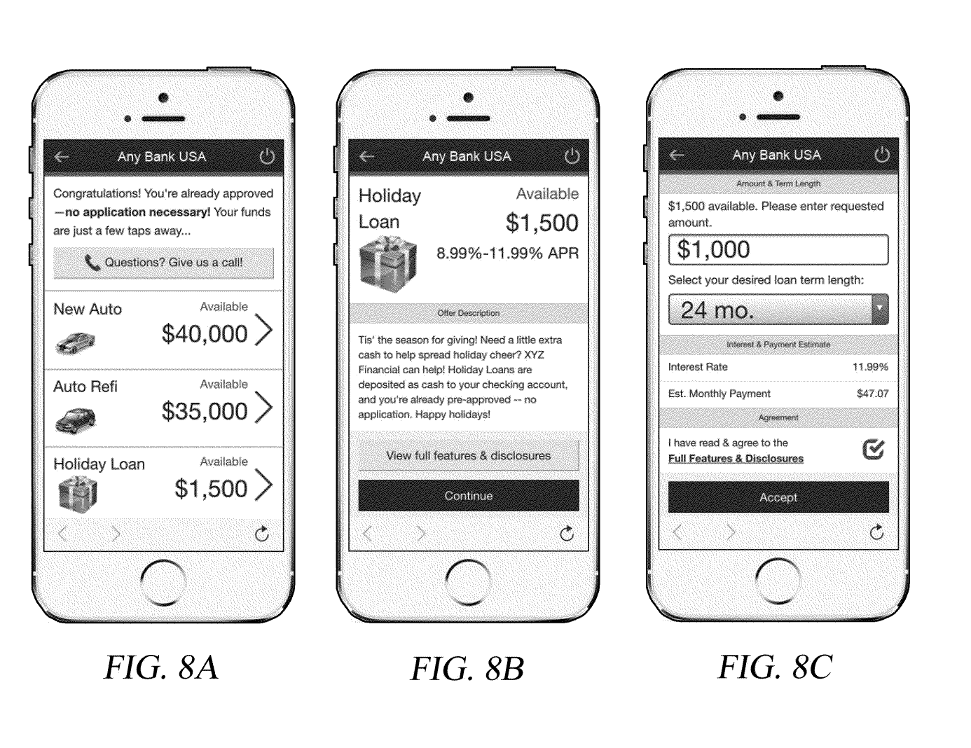

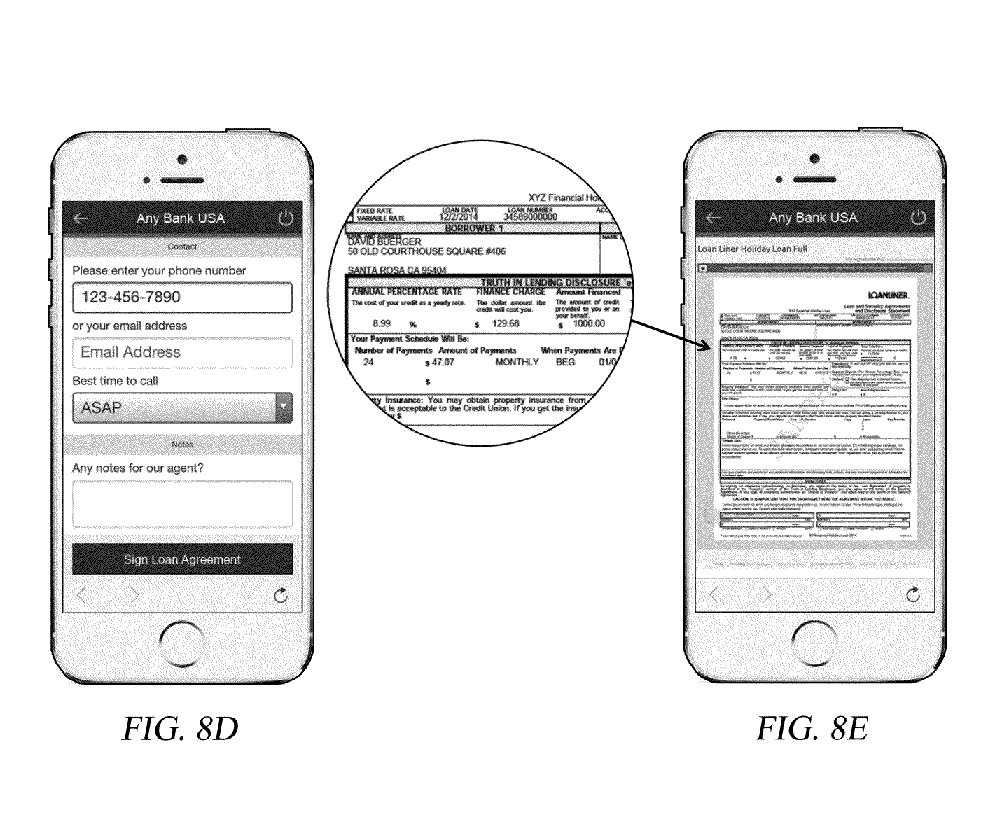

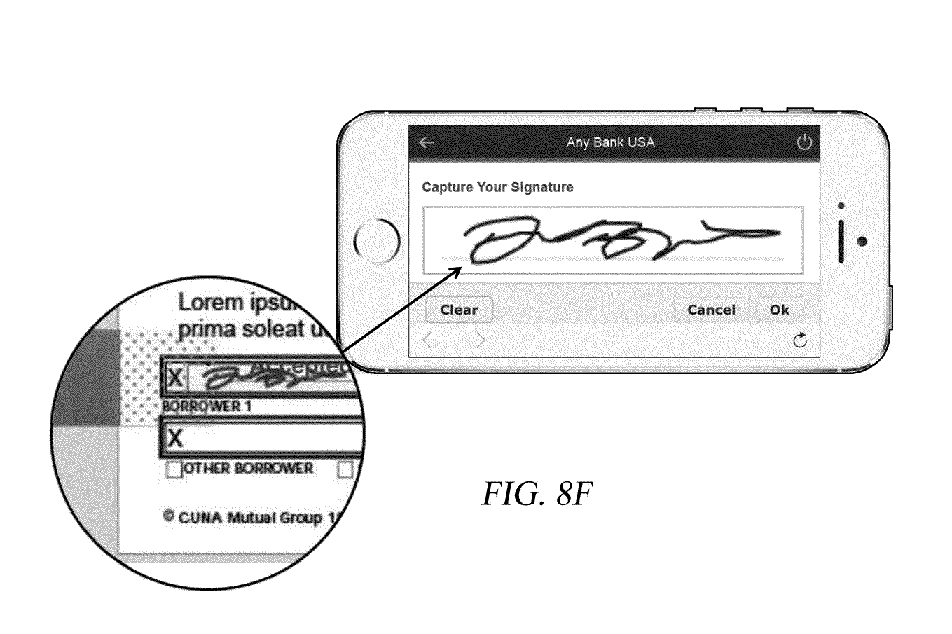

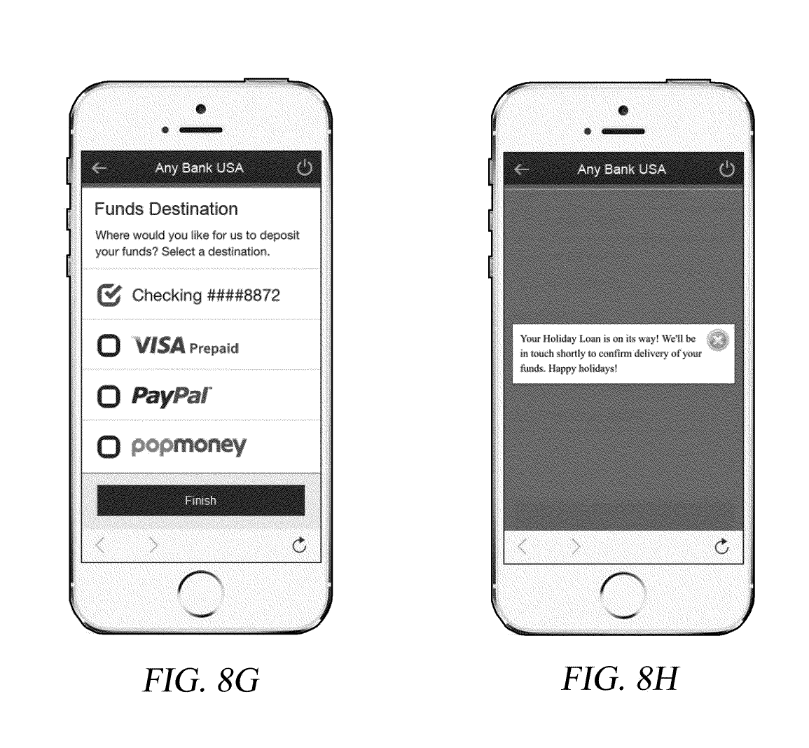

For FIGS. 8A to 8H, the screens for the mobile unit 100 show the pre-approved suite of products on FIG. 8A, the financial details of a holiday loan on FIG. 8B, the payment terms monthly for a given loan amount and interest rate in FIG. 8C, a contact information submission screen at FIG. 8D, the documentation of the holiday loan on FIG. 8E with a blow-up magnification of the documentation fine print, a signature capture screen on FIG. 8F, a funds destination designation on FIG. 8G and the confirmation of funds disbursement on the screen shown at FIG. 8H.

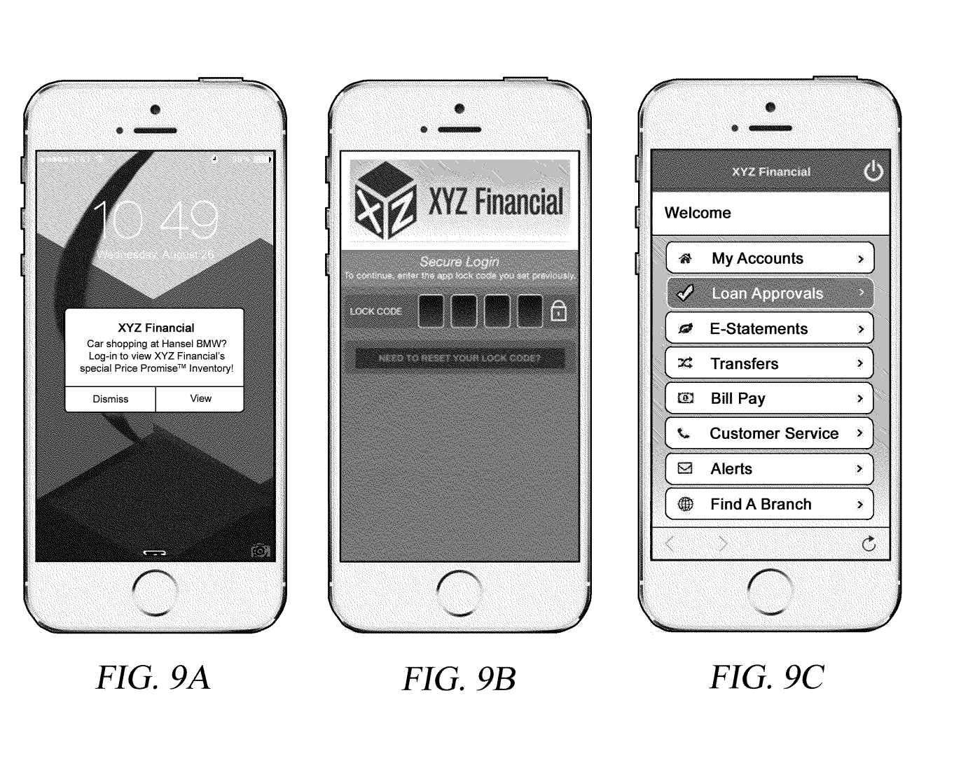

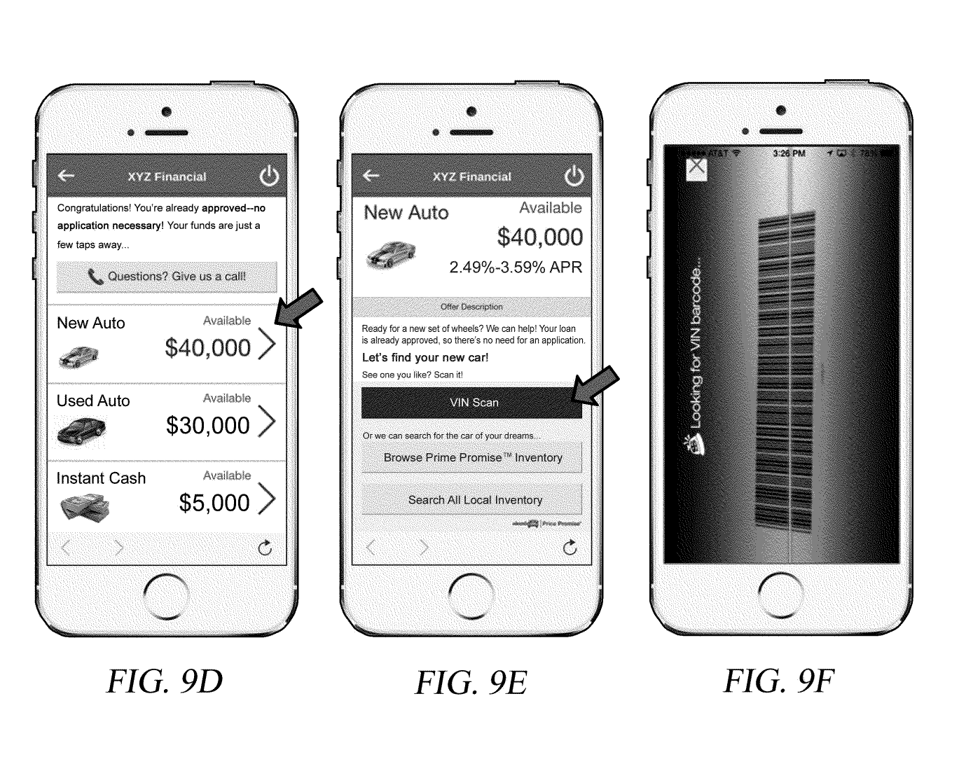

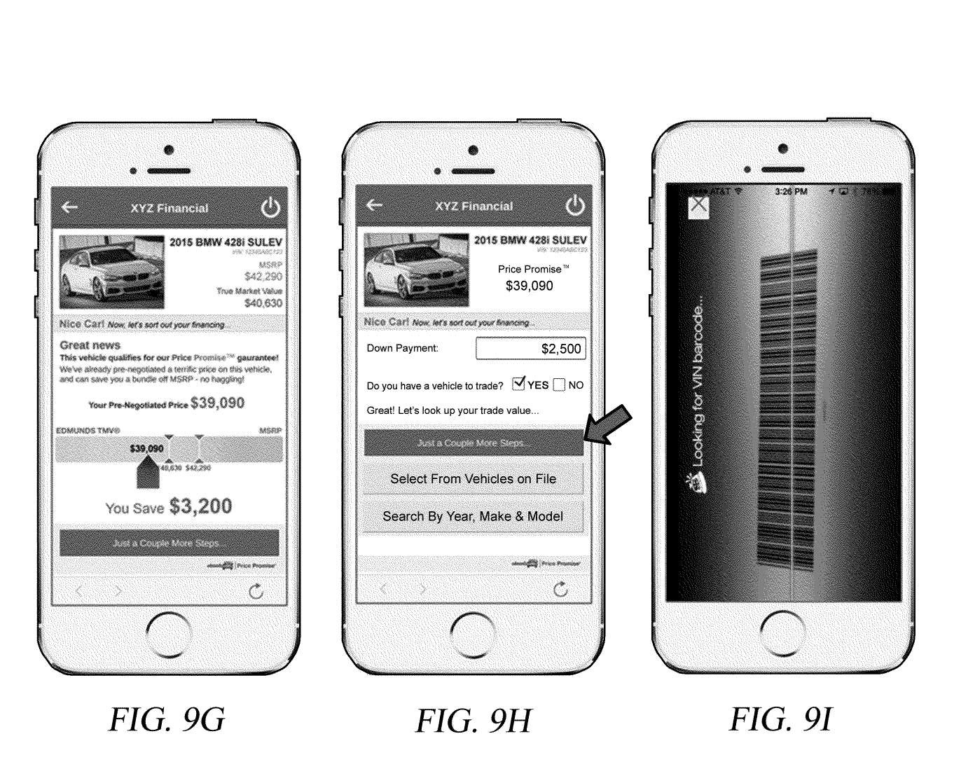

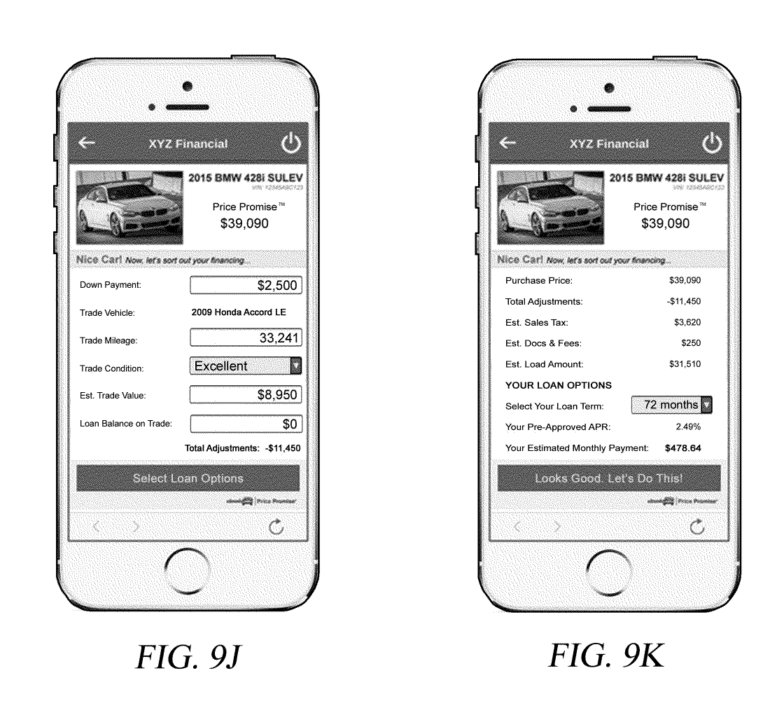

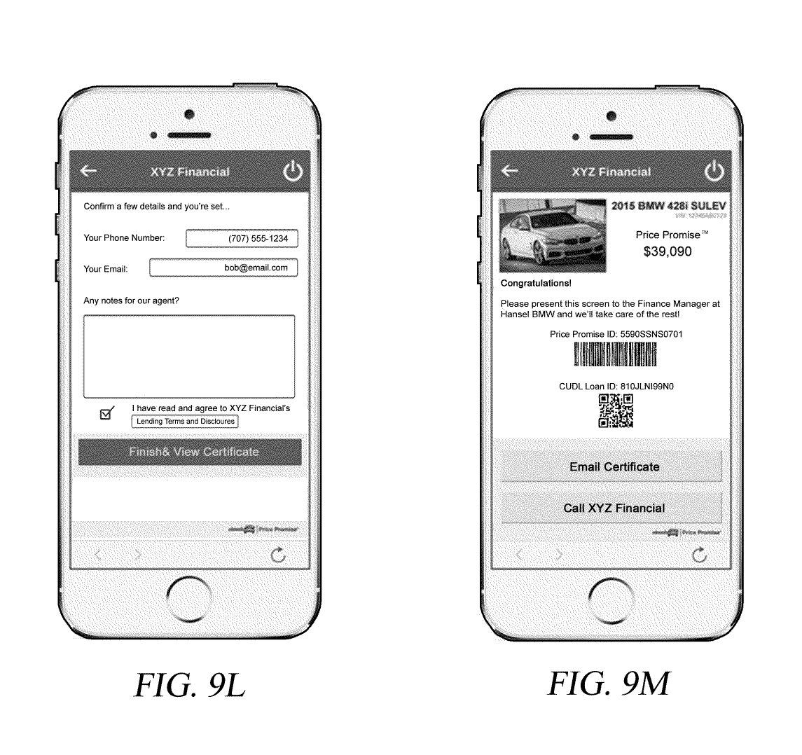

For FIGS. 9A to 9M, the screens for the mobile unit 100 show geo-targeted communication to the consumer on FIG. 9A, the secure log-in screen at FIG. 9B, the Request Selection screen on FIG. 9C, the pre-approved suite of products on FIG. 9D, the financial details of a new auto loan on FIG. 9E, the VIN scanner capture of bar codes on the screen on FIG. 9F, the guaranteed pricing screen on FIG. 9G, the down payment submission request screen on FIG. 9H, the VIN bar code scanner screen on FIG. 9I, the down payment, mileage and condition submission screen on FIG. 9J, the payment terms monthly for a given loan amount and interest rate in FIG. 9K, a contact information submission screen at FIG. 9L, and a loan identification screen for the approved loan amount on FIG. 9M.

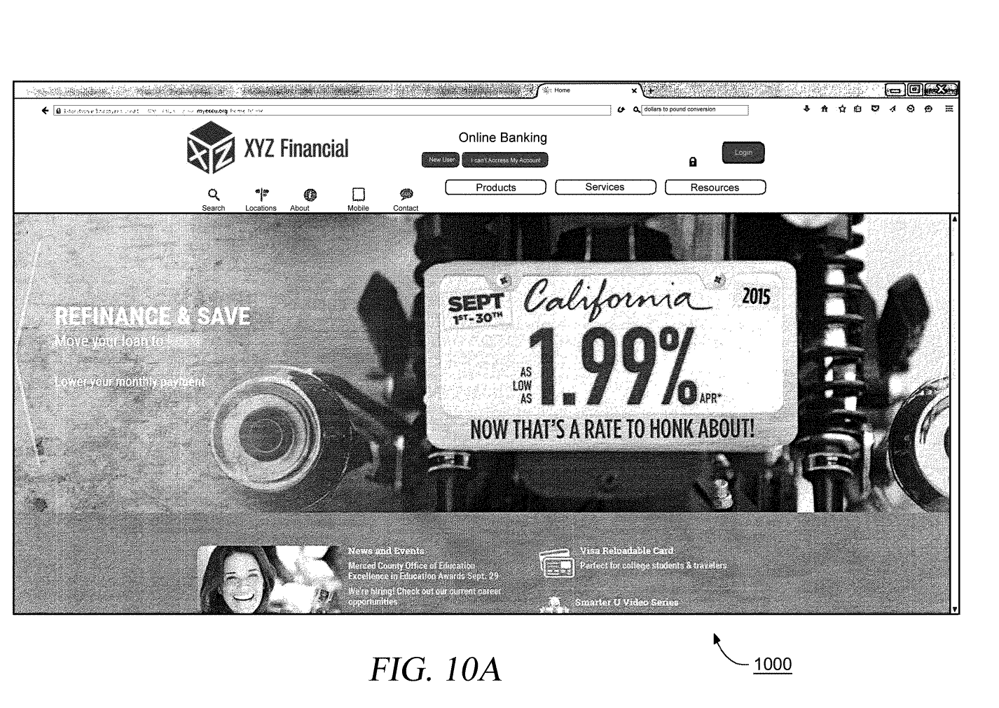

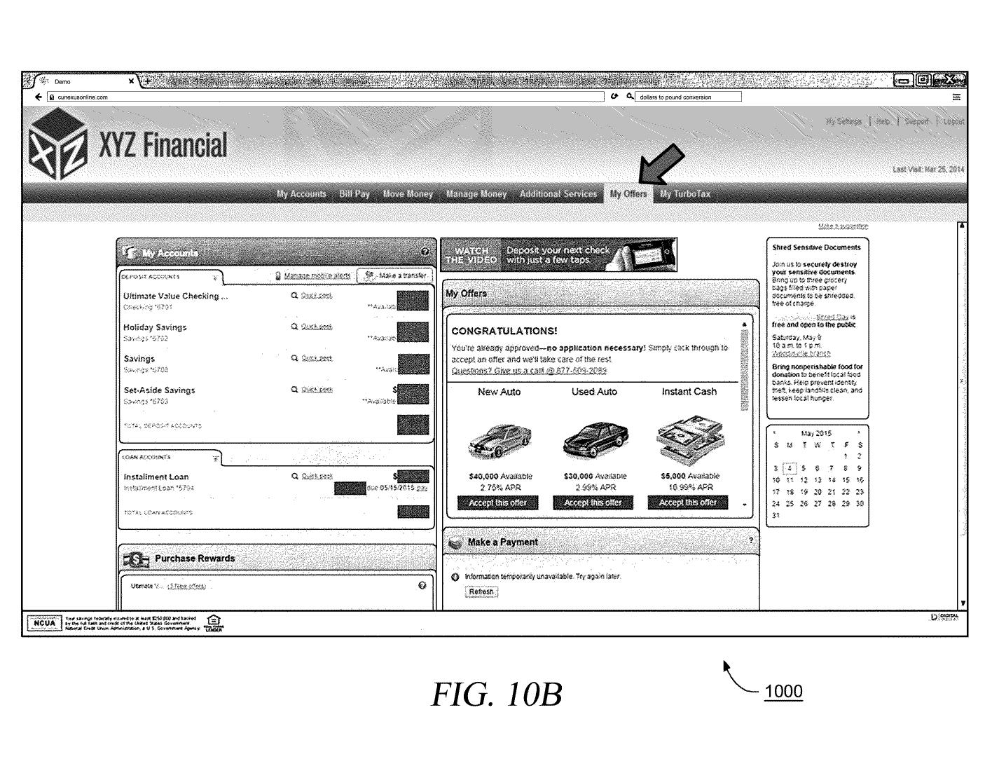

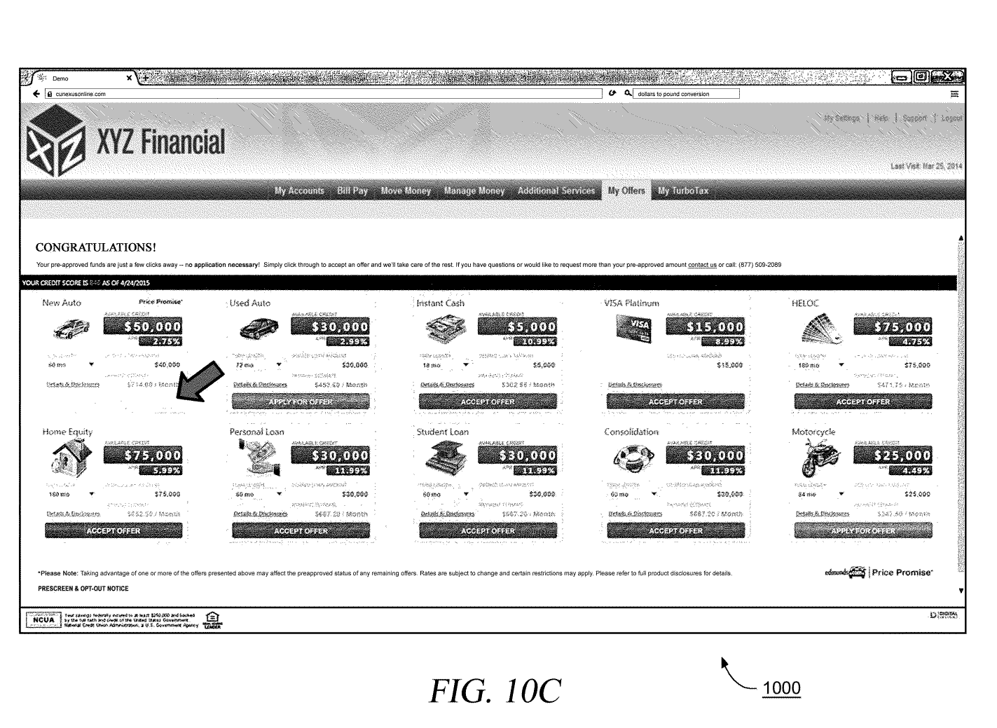

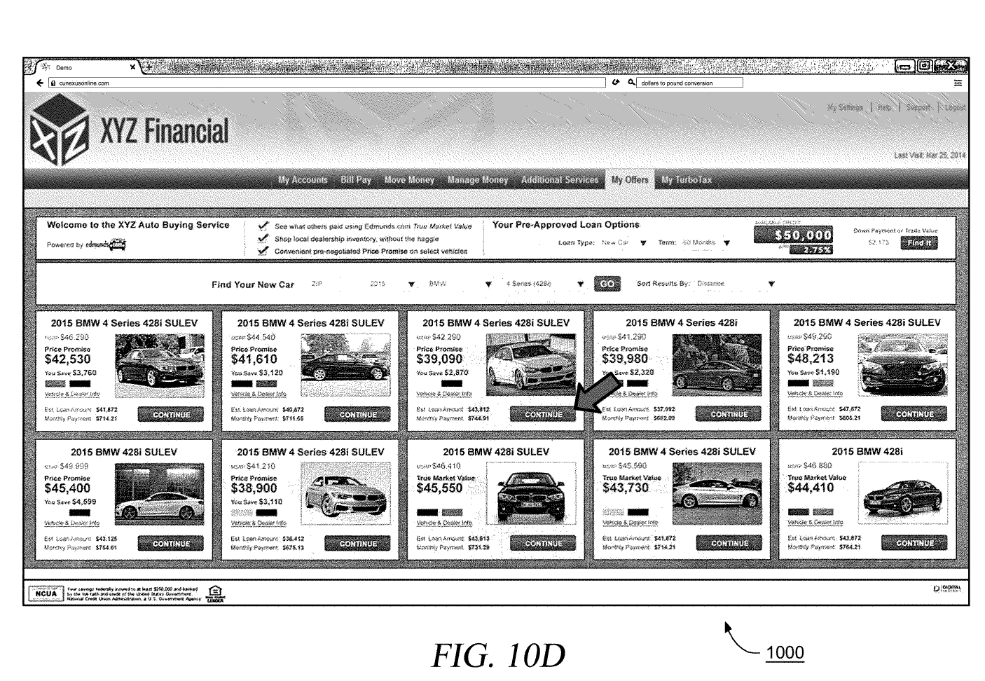

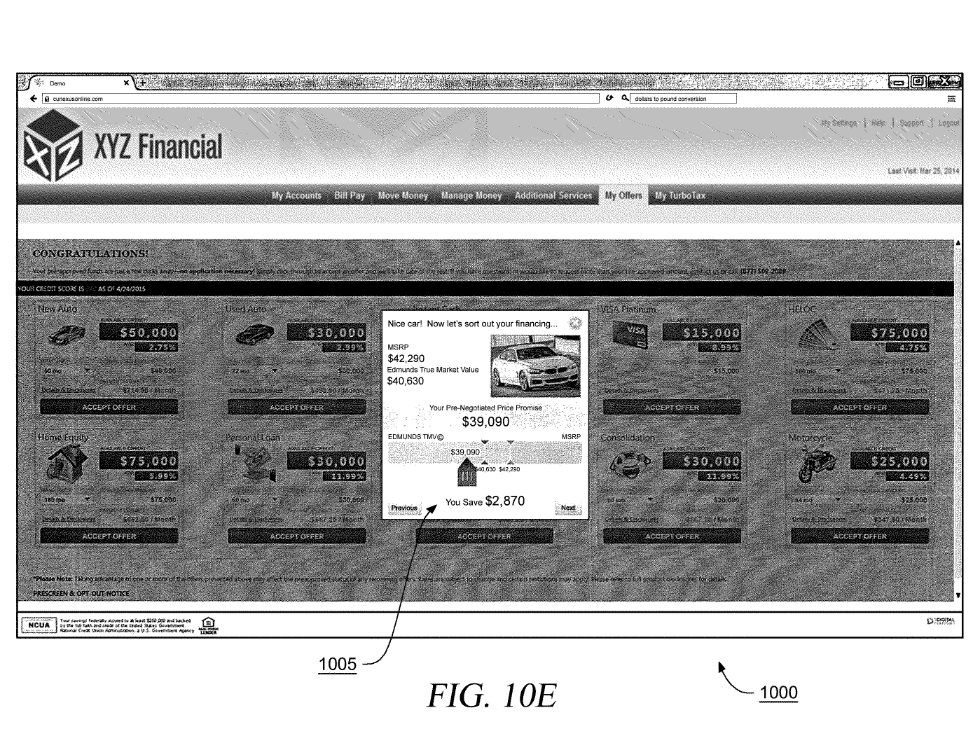

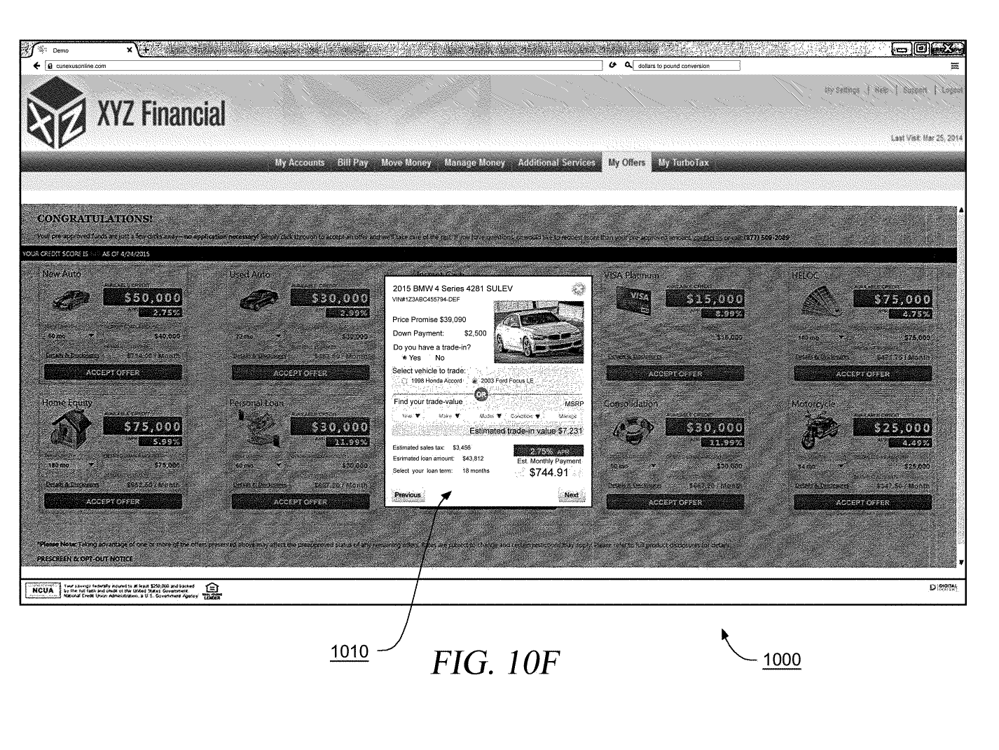

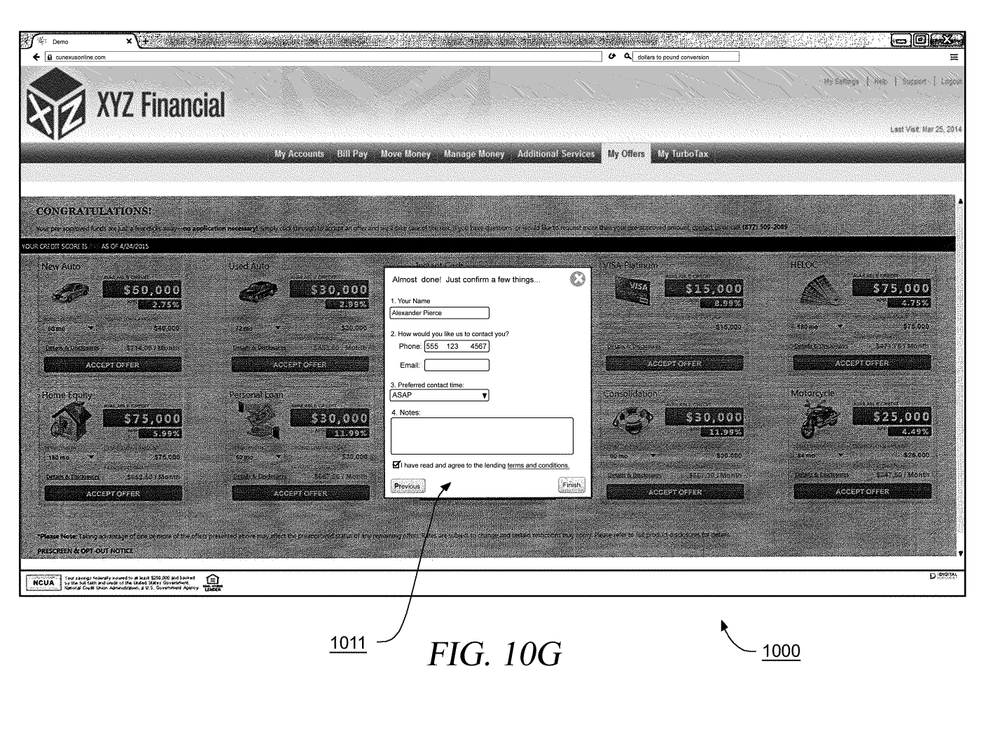

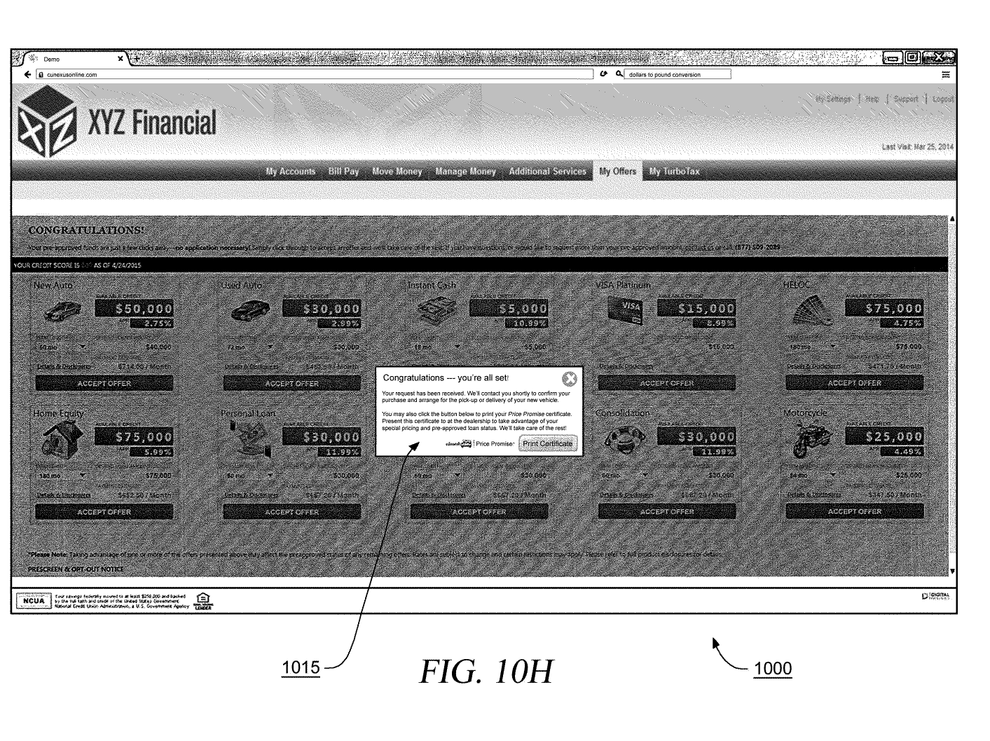

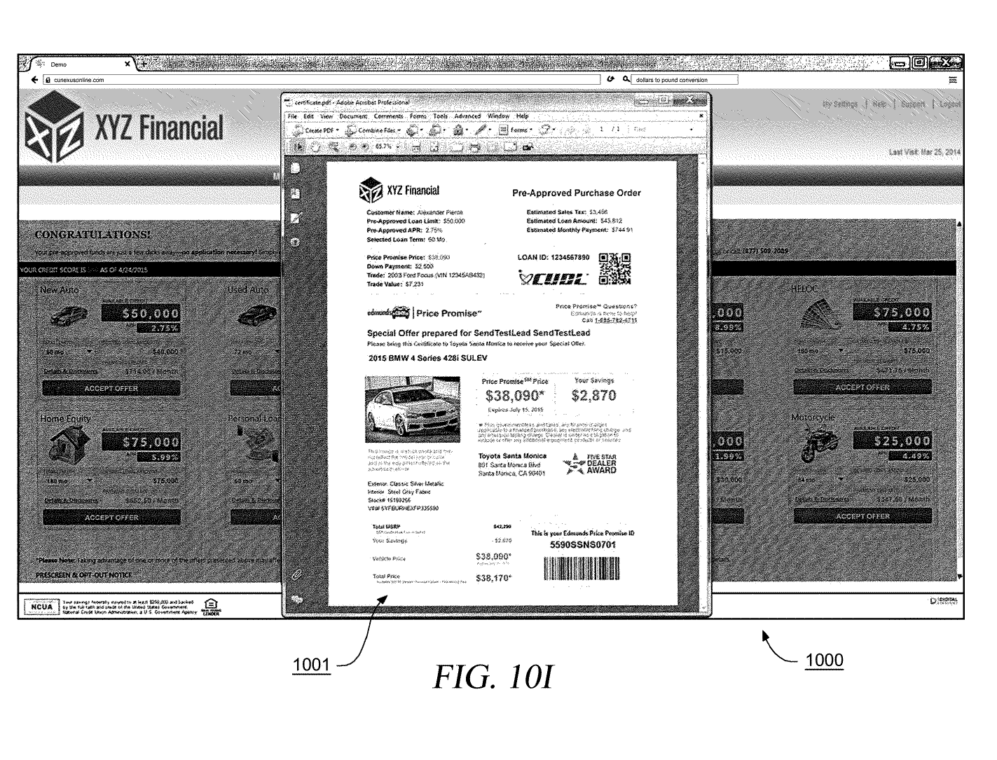

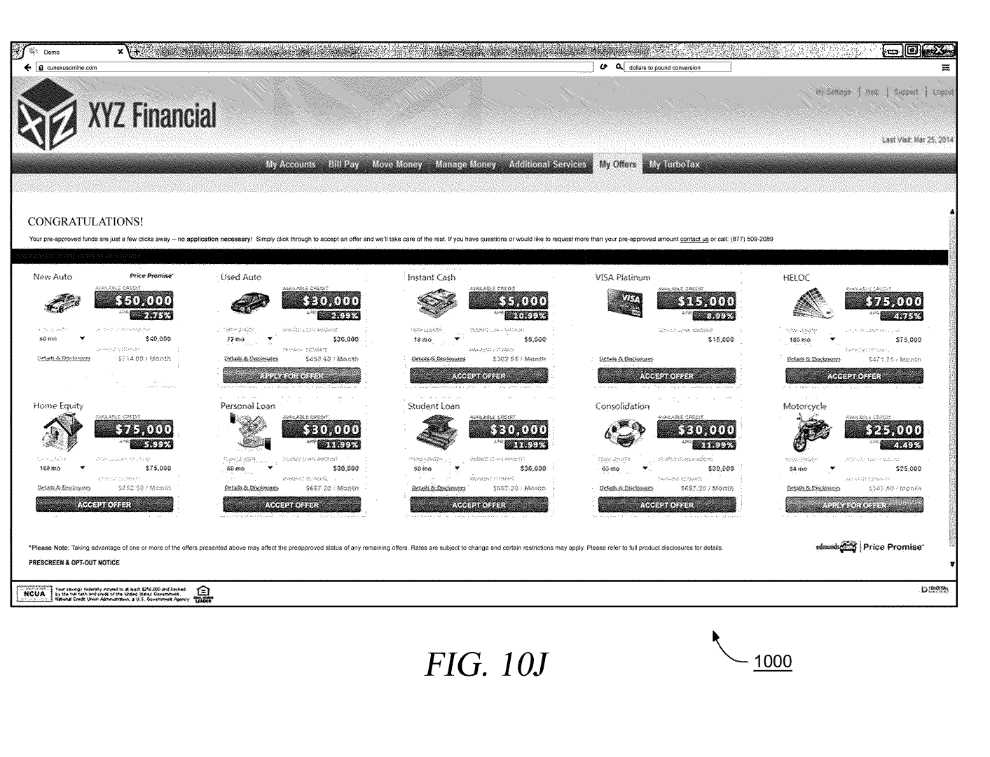

For FIGS. 10A to 10J, the screens for a laptop screen 1000 show the webpage log-in screen at FIG. 10A, the accounts and offers listing page 1000 at FIG. 10B, the pre-approved offers screen 1000 at FIG. 10C, the selection of one pre-approved offers on the screen 1000 at FIG. 10D, the guaranteed pricing screen 1005 on FIG. 10E, the down payment, mileage and condition screen 1010 on FIG. 10F, a contact information submission screen 1011 at FIG. 10G, and a print certificate of loan for the approved loan amount on screen 1015 on FIG. 10H, the certificate of loan approval screen 1001 on FIG. 10I, and updated pre-approved offers screen 1000 at FIG. 10J.

Another embodiment is a custom built system designed to be incorporated into a given user institution's core processing system which is compatible or a part of the operating software of the core processing system. In this embodiment, each interface required is individually programmed. Another embodiment is a functionality which can be incorporated into a software suite or operating system designed to fulfill multiple needs of a user institution. In such an embodiment, the functionality is provided to the developer of the software suite or operating system for incorporation therein. Another embodiment is a web-based system wherein the functionality of the invention can be utilized by a user institution by accessing the web-based system.

Still another embodiment is providing the functionality of the invention to an entity with which the user institution does business in the course of preparing its pre-approved credit offers, such as an independent credit bureau. In such case, the user institution will provide data to the credit bureau which will perform the steps of the method to provide the desired final information to the financial institution or its designee. Regardless of the embodiment employed, the method performed by the system of the invention follows the following further steps. After, the necessary customer data is collected as discussed above from for example a user institution's internal database located in a core processing system and/or external databases, the customer data is transferred to the system of the invention.

In one embodiment, the system can be provided with or programmed with the user institution's criteria for marketing, lending and underwriting. This can be provided to the system through initial set up of the system through a user interface. This functionality would allow the user institution to alter its criteria at any time internally. In addition, the user institution can customize its underwriting criterion much more specifically. For example, it can specify different underwriting flexibility for different codes. The system can then communicate particularized criteria to an outside service vendor credit bureau on an ongoing or real time basis.

In an alternative embodiment, the underwriting criteria will reside in the computer systems of outside service vendors, such as credit bureaus. The user institution generally will send criteria to the credit bureau at a particular time, and the criteria will remain unchanged until the user institution communicates new criteria. In still another embodiment, the system further comprises a functionality that provides forms that can be completed by the user institution to specify underwriting criteria for communication to the credit bureau. The forms can be communicated via an interface provided by the credit bureau or emailed, faxed, mailed or otherwise sent to the credit bureau for input into its computer systems which will be used to generate the data required by the user institution for analysis by the system of the invention.

The customer data is analyzed via an algorithm within a software routine within the system programmed to generate a coded customer relationship profile (CRP). The algorithm takes into account the existing accounts for each individual customer, product/service relationship data (to which a code may or may not have been pre-assigned by the user), account information, and unique identifiers. Output may include CRPs for the entire customer base, or CRPs can be requested for a more limited subset of the customer base, such as a specific segment or segments or for an individual customer. The system utilizes the CRP data set for creating a credit bureau input data set. A software routine in the system is programmed to create the credit bureau input set.

Individual CRPs within the credit bureau input data set are assigned a preliminary profile code by the system. This is arrived at by providing said data to a software routine that is programmed to generate the preliminary profile codes by taking into account the individual customer's current product relationships and how they relate to the institution's product offerings. This preliminary profile code can be assigned before the credit bureau input data is sent to the credit bureau or when the data set returns from the credit bureau after being associated with the customer's credit score. The preferred method is to assign the preliminary profile code to the credit bureau input data to better ensure quality, security and accuracy.

In a preferred embodiment, the CRP data is refined to form the credit bureau input data set via a software routine in said CPL module that is programmed to take one or more refining characteristics into account. This refinement can include, for example, exclusion of individual customers or customer sets. Exclusion criteria may include demographic considerations and/or product/service relationship data contained within CRPs. The refinement step may also be bypassed, so that output data set includes entire customer base (less any exclusions provided for in the CRP generation step).

As is evident from the above, exclusions can be made in one or more steps. The initial set exclusions are considered to be necessary exclusions as defined by the institutions lending criteria—such as the presence of past bankruptcy, delinquent loans, etc. The second set of exclusions are generally more in the realm of marketing and consumer targeting decisions, such as age, geographic area, income, etc. These considerations are optional on the part of the marketer and do not relate to any predefined underwriting/lending parameters.

The credit bureau input data set is encrypted and transmitted to a credit bureau. The credit bureau appends the credit score and other information that it may have such as beacon score, BNI, and tradeline info such as presence of mortgage and mortgage balance to the data set provided to it. The user institution does provide basic underwriting criteria to the credit bureau, generally their minimum approval qualifications. For instance, the lender will indicate that they only wish to pre-approve individuals with a beacon score of at least 640 and a BNI of at least 280 (this is variable, based on the lenders specific eligibility criteria). The credit bureau will then extract the necessary information from the data set and run a pre-screen on all prospective offerees of the user institution's products in the data set, removing all offerees that do not meet the criteria. The credit bureau output set returned to the system will in this preferred embodiment only include information on those who qualified.

In a preferred embodiment, the system includes a function of automated underwriting. In another embodiment, the pre-screen is run through a separate process, and the credit bureau output set entered into the system upon receipt. If opened in a spreadsheet format, the text files' appended information from the credit bureau appears in the credit bureau output set as additional “fields.” The actual fields populated by the credit bureau can change upon request of the user institution. For example, if one opens the transmitted text in a spreadsheet program, column 1 may be last name, column 2 is first name, column 3 address, column 4 a coded social security number and columns 5-9 could be the fields that the credit bureau completes. As one example, these columns could be column 5 beacon score, column 6 BNI, column 7 first mortgage balance, column 8 original mortgage balance, column 9 monthly mortgage payment.

The credit bureau returns a credit bureau output data set appended with credit score information (Beacon and/or BNI). The returned credit bureau output data set will preferably include home ownership status for each individual (presence of mortgage, mortgage balance, and monthly payment). Other information regarding open trade lines may be requested for evaluation as well, depending on the needs of the institution. The credit bureau output data set retrieved from the credit bureau is uploaded to the system for processing via a software routine that is programmed to correlate said credit bureau output data with said preliminary profile code. Credit score data and any mortgage information are appended to said preliminary profile code, thus generating a final profile code assignment.

Additional (optional) approval criteria may be based upon any combination of information contained within the CRP. The tier structure may be based upon other criteria as previously indicated, such as the range of credit score used etc. The system preferably further comprises a functionality to communicate offers to customers. In one embodiment, the system of the invention generates a mailing list associated with financial services offers. In a preferred embodiment, system transmits a customer mailing list to a mail house for direct mail processing and distribution. The customer mailing list preferably contains encrypted profile code and pre-approved offer (rate/loan amount/terms) information for each individual customer. The mail house decodes and utilizes this information to print customized pre-approved offers onto preprinted letter templates.

Such technology has contained, for example, tools that automate underwriting and risk-based lending procedures. In another embodiment, the system may communicate offers via mobile device and/or populate offer communication and/or redemption fields within mobile application(s). In another embodiment, the system may communicate offers via email. The system may assist in creating customizable email lists, transmitting emails, and tracking email marketing efforts. In another embodiment, offers may be communicated to the customer via the Internet. For example, the customer may have a secure web page where he or she may access account information at the financial institution. This can also be used for personal communication to the customer as to pre-approved offers.

The system preferably uploads data either directly or through an intermediate transfer means to the user's customer account database. Codes corresponding to offer tracking can be associated with customer accounts. Tracking code data can be utilized to populate a cross sell/redemption interface for use by phone center and retail sales personnel. Lending criteria may be communicated from the system to a user redemption interface to allow offer modifications based on customer redemptions. The tracking code data can be used to populate offer communication and/or redemption fields within the user's interne banking and/or other online channel(s).

The system also preferably provides data sort and error check. The user is presented with reports including profile code quantities and any other predetermined criteria requested, such as demographic and geographic segment information, and/or performance evaluations. By knowing how many of each profile code are present, the user can determine how many individuals received a particular set of product offers, for example one profile code may indicate auto, credit card and home equity offers, while another code may indicate auto, personal loan, airplane, debt consolidation and boat offers, etc. The user is given the opportunity to perform changes to approval criteria if desired. If the user opts to make changes, the data sort and error check step is performed again. Another use of the data sort and error check functionality is that it may review any offers that do not correlate with the user's requirements, and subsequently provide the customer with the default offer(s) only. Upon user approval of data set, the system may output the offers to the customer.

Customer relationship profile (CRP) reports are generated on a user-defined basis (daily, monthly, annually, etc) and preferably uploaded or otherwise transferred to the system for promotional tracking and analysis. At the completion of any promotional effort, the user may utilize a post-promotional analysis toolkit preferably contained within the system to track results, budget expense, return on investment (ROI), consumer behavior, and other parameters. The post-promotional analysis toolkit also allows the user to compare pre-approval criteria and results from past promotional efforts to help maximize the effectiveness and efficiency of future efforts.

The foregoing description of embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

1-20. (canceled)

21. A communication system supporting the processing of communications between a home network and a mobile unit associated with one or more clients of a financial institution, comprising:
a first computer server on the home network,
said first computer server evaluating one or more clients of said financial institution according to a series of credit analysis matrices to produce a customized list of one or more loan products that will be offered to one or more clients on pre-approved basis,
each of said one or more clients of said financial institution receiving a profile code that corresponds to the one or more pre-approved loan products that will extended to the one or more clients of said financial institution,
said products offered to said one or more clients on pre-approved basis are funded and fulfilled by the financial institution on a real-time, immediate basis upon acceptance by the one or more clients without the need for further applications processing, evaluations, or approvals from the financial institution,
said first computer server maintains and supports use of data, customer information, software modules and operational codes on the home network;
a home agent on the home network coupled to said first computer server,
said home agent controls communications with the mobile unit so the information on said home network is accessible by said mobile unit,
said home agent communicating offers to the mobile unit of one or more pre-approved loan products to the one or more clients of said financial institution,
said home agent receiving and processing acceptances of said pre-approved offers from said mobile unit and facilitating fund transfer to said one or more clients on an immediate, real-time basis,
said home agent processes location and proximity information received from said mobile unit to determine the type of notification message to provide to the mobile unit regarding the pre-approved loan products that are being offered to the one or more clients;
a first database memory storage unit coupled to said home agent and first computer server on said home network,
said first database memory storage unit maintaining information related to the one or more clients of said financial institution that have been offered one or more of the plurality of loan products on a pre-approved basis for funding on a real-time, immediate basis upon acceptance by the clients of the financial institution without the need for further application processing, evaluations or approvals from the financial institution,
said first database memory storage unit having information that is updated to reflect the products accepted by the one or more clients of said financial institution after one of the financial products was fulfilled on an immediate, real-time basis,
said first database memory storage maintains information relating to products in inventory for product sellers, information relating to sales and pricing information, information relating to vehicle identification number information, information relating to location specific information and information relating to product valuation data;
said mobile unit having access to information on maintained on said first memory storage unit through access to the home network;
a transceiver subsystem coupled to said home network through a first gateway providing a communications interface for communications between the home network and said mobile unit, said transceiver subsystem receives and transmits communications between said home network and said mobile unit,
one or more data entry terminals located on said home network for access to the computer server, home agent or database memory storage unit on the home network; and,
a second computer server coupled to said home network and said first database memory storage unit, said second computer server facilitating communications to said home network through the Internet.

22. A communication system according to claim 21 wherein said one of said one or more pre-approved loan products includes a car loan.

23. A communication system according to claim 21 wherein said one of said one or more pre-approved loan products includes a home equity loan.

24. A communication system according to claim 21 wherein said one of said one or more pre-approved loan products includes a personal loan.

25. A communication system according to claim 21 wherein said one of said one or more pre-approved loan products includes a motorcycle loan.

26. A communication system according to claim 21 wherein said one of said one or more pre-approved loan products includes a student loan.

27. A communication system according to claim 21 wherein said one of said one or more pre-approved loan products includes an instant cash loan.

28. A communication system according to claim 21 wherein said one of said one or more pre-approved loan products includes a debt consolidation loan.

29. A communication system supporting the processing of communications between a home network and a mobile unit associated with one or more clients of a financial institution, comprising:
a first computer server on the home network,
said first computer server evaluating one or more clients of said financial institution according to a series of credit analysis matrices to produce a customized list of one or more loan products that will be offered to one or more clients on pre-approved basis,
each of said one or more clients of said financial institution receiving a profile code that corresponds to the one or more pre-approved loan products that will extended to the one or more clients of said financial institution,
said products offered to said one or more clients on pre-approved basis are funded and fulfilled by the financial institution on a real-time, immediate basis upon acceptance by the one or more clients without the need for further applications processing, evaluations, or approvals from the financial institution,
a home agent on the home network coupled to said first computer server,
said home agent controls communications with the mobile unit so the information on said home network is accessible by said mobile unit,
said home agent communicating offers to the mobile unit of one or more pre-approved loan products to the one or more clients of said financial institution,
said home agent receiving and processing acceptances of said pre-approved offers from said mobile unit and facilitating fund transfer to said one or more clients on an immediate, real-time basis,
a first database memory storage unit coupled to said home agent and first computer server on said home network,
said first database memory storage unit maintaining information related to the one or more clients of said financial institution that have been offered one or more of the plurality of loan products on a pre-approved basis for funding on a real-time, immediate basis upon acceptance by the clients of the financial institution without the need for further application processing, evaluations or approvals from the financial institution,
said first database memory storage unit having information that is updated to reflect the products accepted by the one or more clients of said financial institution after one of the financial products was fulfilled on an immediate, real-time basis,
said first database memory storage maintains information relating to products in inventory for product sellers, information relating to sales and pricing information, information relating to vehicle identification number information, information relating to location specific information and information relating to product valuation data;
said mobile unit having access to information on maintained on said first memory storage unit through access to the home network;
a transceiver subsystem coupled to said home network through a first gateway providing a communications interface for communications between the home network and said mobile unit, said transceiver subsystem receives and transmits communications between said home network and said mobile unit, and,
a second computer server coupled to said home network and said first database memory storage unit, said second computer server facilitating communications to said home network through the Internet.

30. A communication system according to claim 29 wherein said home agent processes location and proximity information received from said mobile unit to determine the type of notification message to provide to the mobile unit regarding the pre-approved loan products that are being offered to the one or more clients.

30. A communication system according to claim 29 wherein said first computer server maintaining and supporting use of data, customer information, software modules and operational codes on the home network.

31. A communication system according to claim 29 wherein said first computer server maintaining and supporting use of data, customer information, software modules and operational codes on the home network.

32. A communication system according to claim 29 wherein said first computer server maintaining and supporting use of data, customer information, software modules and operational codes on the home network.

33. A communication system according to claim 29 wherein said one of said one or more pre-approved loan products includes a car loan.

34. A communication system according to claim 29 wherein said one of said one or more pre-approved loan products includes a home equity loan.

35. A communication system according to claim 29 wherein said one of said one or more pre-approved loan products includes a personal loan.

36. A communication system according to claim 29 wherein said one of said one or more pre-approved loan products includes a motorcycle loan.

37. A communication system according to claim 29 wherein said one of said one or more pre-approved loan products includes a student loan.

38. A communication system according to claim 29 wherein said one of said one or more pre-approved loan products includes an instant cash loan.

39. A communication system according to claim 29 wherein said one of said one or more pre-approved loan products includes a debt consolidation loan.

40. A communication system according to claim 29 further comprising:
one or more data entry terminals located on said home network for access to the computer server, home agent or database memory storage unit on the home network.

41. A method for processing communications between a home network and a mobile unit associated with one or more clients of a financial institution, comprising the steps of:
evaluating on a first computer server on the home network one or more clients of said financial institution according to a series of credit analysis matrices to produce a customized list of one or more loan products that will be offered to one or more clients on pre-approved basis,
associating a profile code for each of said one or more clients of said financial institution, said profile code corresponding to the one or more pre-approved loan products that will extended to the one or more clients of said financial institution,
extending by a communication from a home agent on the home network to the mobile unit one or more pre-approved loan products to said one or more clients on pre-approved basis, said home agent coupled to said first computer server and said pre-approved loan products capable of being funded and fulfilled by the financial institution on a real-time, immediate basis upon acceptance by the one or more clients without the need for further applications processing, evaluations, or approvals from the financial institution;
receiving an acceptance of one or more pre-approved loan products from said mobile until at said home agent on said home network, said acceptance received by the home agent initiating the facilitation and funding of said loan products to said one or more clients on an immediate, real-time basis;
maintaining information on a first database memory storage unit coupled to said home network, said first database memory storage unit maintaining information related to the one or more clients of said financial institution that have been offered one or more of the plurality of loan products on a pre-approved basis for funding on a real-time, immediate basis upon acceptance by the clients of the financial institution without the need for further application processing, information relating to evaluations or approvals from the financial institution,
updating information on said first database memory storage unit to reflect the products accepted by the one or more clients of said financial institution after one of the financial products was fulfilled on an immediate, real-time basis;
providing a communications interface for communications to the home network through a transceiver subsystem and a first gateway located on said home network;
accessing the computer server, home agent or database memory storage unit on said home network through one or more data entry terminals located on said home network; and,
facilitating communications to said home network from a second computer server coupled to said home network and said first database memory storage unit.

42. The method of claim 41 wherein said first computer server maintains and supports use of data, customer information, software modules and operational codes on the home network.

43. The method of claim 41 wherein said first computer server maintains and supports use of data, customer information, software modules and operational codes on the home network.

44. The method of claim 41 wherein said first computer server maintains and supports use of data, customer information, software modules and operational codes on the home network.

45. The method of claim 41 wherein said one of said one or more pre-approved loan products includes a car loan.

46. The method of claim 41 wherein said one of said one or more pre-approved loan products includes a home equity loan.

47. The method of claim 41 wherein said one of said one or more pre-approved loan products includes a personal loan.

48. The method of claim 41 wherein said one of said one or more pre-approved loan products includes a motorcycle loan.

49. The method of claim 41 wherein said one of said one or more pre-approved loan products includes a student loan.

50. The method of claim 41 wherein said one of said one or more pre-approved loan products includes an instant cash loan.

51. The method of claim 41 wherein said one of said one or more pre-approved loan products includes a debt consolidation loan.

52. The method of claim 41 wherein said database maintains information relating to products in inventory for product sellers.

53. The method of claim 41 wherein said database maintains information relating to sales and pricing information.

54. The method of claim 41 wherein said database maintains information relating to vehicle identification number information.

55. The method of claim 41 wherein said database maintains information relating to location specific information.

56. The method of claim 41 wherein said database maintains information relating to product valuation data.
